(19) United States
(12) Patent Application Publication
(10) Pub. No.: US 2024/0149552 A1
(43) Pub. Date: May 9, 2024

(54) MULTI-USE COMPOSITE

(71) Applicant: SERPENT SCALE SYSTEMS LLC, South Bristol, ME (US)

(72) Inventors: William PETERSON, South Bristol, ME (US); Benjamin FEARN, South Bristol, ME (US); Amanda E. SIMILIEN, Brunswick, ME (US)

(73) Assignee: SERPENT SCALE SYSTEMS LLC, South Bristol, ME (US)

(21) Appl. No.: 18/550,033

(22) PCT Filed: Mar. 10, 2022
(86) PCT No.: PCT/US2022/019764

§ 371 Date: Sep. 11, 2023

Related U.S. Application Data
(60) Provisional application No. 63/178,919, filed on Apr. 23, 2021.
(60) Provisional application No. 63/159,724, filed on Mar. 11, 2021.

(51) Int. Cl. B32B 5/18; B32B 5/16; B32B 7/12

(52) U.S. Cl. CPC B32B 5/18; B32B 5/16; B32B 7/12; B32B 2250/02; B32B 2250/24; B32B 2260/025; B32B 2260/046; B32B 2262/101; B32B 2264/0207; B32B 2305/026; B32B 2305/08; B32B 2307/3065

(57) ABSTRACT

A composite for energy absorbing, non-slip surfaces is disclosed. The composite may be an elastomeric layer deposited and adhered to the surface of a substrate. The substrate may be a polymeric foam, a polyurethane, a closed-cell polyurethane foam or a metal. The elastomeric layer may include a plurality of elastomeric granules, made of a granulated synthetic rubber or more particularly a granulated Ethylene-Propylene-Diene-Monomer. The adhesive used to adhere the elastomeric layer to the substrate may be the same adhesive used to bind the elastomeric granules to one another. In some instances, the composite may include embedded devices or indicia. Composites in accordance with the present disclosure create a safer and more durable surface for marine and construction industries.

### RELATED APPLICATIONS

This application claims priority to International Application No. PCT/US2022/019764 and claims benefit of U.S. Provisional Application No. 63/159,724, filed Mar. 11, 2021, and claims benefit of U.S. Provisional Application No. 63/178,919, filed Apr. 23, 2021. These three applications are incorporated by reference in their entirety herein.

### BACKGROUND

### 1. Field of the Disclosure

The present disclosure relates to composites, and more particularly, elastomeric, impact absorbing, multi-use composites for non-slip applications.

### 2. Discussion of Related Art

Working surfaces in the marine and construction industries are often exposed to harsh climate conditions such as excessive moisture, sunlight (ultra-violet), and extreme temperature exposure. Surfaces made of wood and metal are frequently used on marine decks and docks, as well as in construction applications such as walkways on scaffolding. Non-slip surfaces have been applied to these materials with mixed success as the applied surfaces often degrade or delaminate, leading to frequent replacement.

### SUMMARY

In one aspect, the composite includes a reinforced polymer substrate with an elastomeric layer disposed on the surface of the substrate. This elastomeric layer includes a plurality of non-slip elastomeric granules that are adhered together with an adhesive, the same adhesive that adheres the elastomeric layer to the substrate. In this aspect, the elastomeric layer is securely bonded to the substrate to form a composite requiring a tensile force of greater than 35,000 psi to separate the elastomeric layer from the reinforced polymer substrate.

In some embodiments, the adhesive used is a flexible binding medium and can comprise a polyurethane. In some aspects of these embodiments, this polyurethane is a straight-chain aliphatic polyurethane.

In some cases, the elastomeric granules are latex-free, a granule elastomer, and/or a synthetic rubber. In some cases, the elastomeric granules comprise Ethylene-Propylene-Diene-Monomer otherwise known as EPDM. In some of these embodiments, each elastomeric granule has a size ranging from 1-3.5 mm and can exhibit a standard deviation is size of no greater than 1.0 mm or 0.5 mm.

The composite, in some embodiments, can be configured to resist and protect against a number of hazards. For example, the composite may have a wet dynamic coefficient of friction of 0.95±0.05 for the top surface of the elastomeric layer. In some embodiments, the composite is able to resist temperatures up to and including 300° F. The composite can be fire resistant and/or can withstand long term radiation exposure, particularly in the UV spectrum having a wavelength between 250-320 nm.

In this and other aspects, the polymer of the substrate can be a polymeric foam such as a high-density polyurethane closed-cell foam. In some embodiments, the substrate is reinforced, for example, with glass fibers.

The composite may include one or more indicia embedded in the elastomeric layer and the indicia may have similar physical and mechanical traits to the composite, such as having a high coefficient of friction, resisting radiation having a wavelength from 250-320 nm, and/or resisting fire damage.

In another aspect, the composite may include a substrate, which can be a reinforced cellular polymer sheet, and an elastomeric layer, which is deposited on the substrate and adhered with an adhesive. The elastomeric layer includes a plurality of elastomeric granules adhered together with the adhesive. In this aspect, the substrate averages a thickness from 0.25″ to 1.00″, and the elastomeric layer averages a thickness from 0.25″ to 2.00″. The composite, of this embodiment, requires a tensile stress of greater than 35,000 psi to separate the elastomeric layer from the substrate.

The adhesive used in this or other aspects of the composite can be a polyurethane or even more specifically a straight-chain aliphatic polyurethane. In this or other aspects, the adhesive may have a viscosity between 30000 to 40000 mPa-s and/or it may have the molecular weight between 1000 and 6000 Da.

In some embodiments, the rigidity of the composite may be greater than the rigidity of the substrate. In this or other embodiments, the composite may be buoyant in sea water and/or fresh water. The density of the composite may be less than 1.5, less than 1.2, less than 1.0, less than 0.9, or less than 0.8 g/cc.

In some cases, where the composite is cambered, the composite may have a curve radius of less than 50 m, 10 m, less than 5 m, less than 2 m, or less than 1 m. The composite can be electrically insulative and may have a dielectric strength of greater than 1, greater than 5, greater than 10, greater than 15, or greater than 20 kV/mm.

In some embodiments, at least a portion of the elastomeric layer defines an indicium, such as a logo, decorative design, or safety marking. When an embodiment involves two or more composites being joined together, they may be joined by a tongue and groove, wedge, or beveled joint. In this or other embodiments, the two or more composites may be joined by the adhesive, or other adhesives.

Additional devices may be embedded in the composite. In some embodiments, the device may be at least partially embedded in the elastomeric layer. In this or other embodiments, the device may be partially embedded in the substrate. In some cases, devices may include light emitting diodes, sensors, or a length of heat tape. In these aspects, the composite may also comprise a power input or power supply embedded or partially embedded in the elastomeric layer, substrate, or both.

In another aspect, a method for manufacturing a composite is disclosed. The method comprises treating a surface of a metallic substrate with an acidic solution, rinsing the acidic solution from the surface, and drying the surface. Then, abrading the surface to produce a surface roughness of less than 70 μin. After abrading, the abraded surface is treated with the acidic solution, then rinsed and dried the acidic solution from the abraded surface. After the surface is rinsed and dried, the process continues by depositing an uncured bonding layer on the abraded surface, the bonding layer includes a liquid adhesive that is free of solids, then an elastomeric layer is deposited on the bonding layer after it has set and before it has cured. The elastomeric layer includes a plurality of elastomeric granules mixed with the liquid adhesive. After depositing both layers, the process continues by curing the elastomeric layer.

In some examples, the substrate may comprise aluminum. In this example, the acidic solution may have a pH of less than 4.0, comprise muriatic acid, and/or comprise potassium bitartrate and an aqueous solution of acetic acid. In some examples, the surface may be abraded with greater than 80 grit abrasion. In the same or alternative examples, the surface may be abraded with less than 120 grit abrasion.

In an alternative example, the substrate may comprise steel. Where the substrate is steel, the substrate may be wiped with a polar aprotic solvent, and/or the solvent may be acetone. Where the substrate is steel the substrate may be abraded with 320 grit or coarser abrasive. Alternatively, the substrate may be first abraded with at least 320 grit abrasive and then with greater than or equal to 1000 grit abrasive.

The composite's elastomeric layer may be cured at greater than 8 degrees Celsius and/or less than 25 degrees Celsius. Similarly, the composite's elastomeric layer may be cured at a relative humidity greater than 25% and/or less than 55%.

In one example, a composite may comprise a substrate comprising aluminum, an elastomeric layer disposed on a surface of the substrate and adhered to the surface with an adhesive. The elastomeric layer may further include a plurality of elastomeric granules adhered together with the adhesive. In this example, a tensile force of at least 35,000 psi is required to separate the elastomeric layer from the substrate.

In an example, the elastomeric layer is non-porous and/or may have a coefficient of friction of 0.95±0.05.

The adhesive used in this or other aspects of the composite may be a polyurethane, or more specifically a straight-chain aliphatic polyurethane.

In this or other examples, the elastomeric granules may be a granulated elastomer, or more specifically a synthetic rubber, or even more specifically an Ethylene-Propylene-Diene-Monomer. These elastomeric granules may have a size ranging from 1-3.5 mm and, in the same or alternative composites, they may have a standard deviation of less than 0.5 mm. The elastomeric granules may resist temperatures up to and including 300 degrees F.

In some examples, the substrate may consist of magnesium, copper, and/or chromium. In the same or alternative examples, the substrate may be an aluminum alloy. Alloys may include 5052, 5083, 5086, 5454, 5456, 5754, 6061, 6063, or 7075.

Some composites may further include an electronic component embedded in the elastomeric layer. Similarly, some composites may further include an indicium in the surface of the elastomeric layer.

The composite is configured to resist fire and radiation wavelengths from 250-320 nm. In examples that include an indicium, the indicium may also be configured to resist fire and radiation wavelengths from 250-320 nm.

In another aspect, the composite may comprise a metal substrate and an elastomeric layer, where the substrate is adhered to the top surface with an adhesive, and where a tensile force of greater than 35,000 psi is required to separate the elastomeric layer. The substrate includes a top surface, bottom surface opposing the top surface, and a vertical distance between the top and bottom surface from 0.03″ to 0.50″. The elastomeric layer has a top surface and a bottom surface opposing the top surface, and a plurality of elastomeric granules deposited over the top surface of the substrate and adhered together with an adhesive. The elastomeric layer has an average vertical distance between the top surface and the bottom surface from 0.25″ to 2.00″.

The adhesive may be a polyurethane, or more specifically it may be a straight-chain aliphatic polyurethane. Further, the adhesive may have a viscosity between 30000 to 40000 mPa-s and a molecular weight between 1000 and 6000 Da.

The elastomeric granules may be an elastomer material, a granulated synthetic rubber material, or more specifically an Ethylene-Propylene-Diene-Monomer. The diameter of each elastomeric granule may be between 1-3.5 mm and may have a standard deviation of the average diameter between granules of less than 0.5 mm.

In some embodiments, the metal used for the substrate may be aluminum or a carbon steel, or more specifically it may be a A36, DH36, EH36, or HY80 carbon steel. Alternatively, the steel used for the substrate may be a stainless steel, or more specifically a 304 or 316 stainless steel.

In this or other embodiments, the elastomeric layer defines an indicium. In some examples, the composite may have a greater rigidity then the substrate. The composite may be resistant to radiation in the range of 250-320 nm. It may be first resistant up to 300 degrees F. In some embodiments, the composite may be buoyant in sea water and/or fresh water. The composite may have a density of less than 8.0, less than 6.0, less than 5.0, less than 2.5, or less than 1.0 g/cc. The composite may be a planar, moveable, sheet. The composite may have a camber to its shape of a curve radius of less than 1000 m, less than 100 m, less than 10 m, less than 5 m, less than 2 m, or less than 1 m. In other embodiments, the curve radius can be greater than 1 m, greater than 10 m or greater than 100 m. The composite, in this or other embodiments, may have an electrical resistivity of greater than 10¹⁰, 10¹¹, 10¹², 10¹³, 10¹⁴, 10¹⁵ or 10¹⁶ ohm-cm. The dielectric strength may be greater than 1, greater than 5, greater than 10, greater than 15 or greater than 20 kV/mm.

In some aspects, the composite may be joined to a second composite via a tongue and groove, wedge, or beveled joint. The joint may be secured by adhesive or mechanical fastener. In some embodiments, the composite may have an embedded electrical device, at least partially embedded in the elastomeric layer. The device may also be at least partially embedded in the substrate, and the composite further comprises an insulator between the substrate and at least one embedded device. The embedded device may be a light emitting diode, a sensor, and/or a length of heat tap. In this or other examples, the composite may include a power input, or a power supply embedded in the elastomeric layer, insulated from the substrate.

### BRIEF DESCRIPTION OF THE DRAWINGS

FIG. 1a is an isometric view of an example planar composite, in accordance with an embodiment of the present disclosure.

FIG. 1B is an isometric view of an example cambered composite, in accordance with an embodiment of the present disclosure.

FIG. 1c is an isometric view of an example composite, in accordance with an embodiment of the present disclosure.

FIG. 1d is an isometric view of an example composite, in accordance with an embodiment of the present disclosure.

FIG. 2 is a cross-sectional view of the layers of the example composite of FIG. 1a.

FIG. 3 is an enlarged schematic of the non-slip, high traction layer of the composite of FIG. 1a.

FIG. 4a is an isometric view of the example composite of FIG. 1a with embedded safety markings.

FIG. 4b is an image of two example composites with embedded markings, in accordance with an embodiment of the present disclosure.

FIG. 5a is an isometric view of the example composite of FIG. 1a with embedded illumination devices.

FIG. 5b is an isometric view of an example composite, in accordance with an embodiment of the present disclosure.

FIG. 6 is a flowchart of an example manufacture process of a composite, in accordance with an embodiment of the present disclosure.

FIG. 7a is a profile of two adjacent example composites joined with a beveled edge joint, in accordance with an embodiment of the present disclosure.

FIG. 7b is a profile of two adjacent example composites joined with a wedge edge joint, in accordance with an embodiment of the present disclosure.

FIG. 7c is a profile of two adjacent example composites joined with a tongue and groove joint, in accordance with an embodiment of the present disclosure.

FIG. 7d is a profile of two adjacent example composites with flush edges, in accordance with an embodiment of the present disclosure.

FIG. 7e is a profile of two adjacent example composites with a lip and groove joint, in accordance with an embodiment of the present disclosure.

FIG. 7f is a profile of two adjacent example composites with an offset joint, in accordance with an embodiment of the present disclosure.

FIG. 7g is a profile of two adjacent example composites with an angled offset joint, in accordance with an embodiment of the present disclosure.

FIG. 8 is a table of test results from American Society of Testing and Materials (ASTM) standard tests conducted on a composite, in accordance with an embodiment of the present disclosure.

FIG. 9 is a flowchart of an example manufacture process of a composite, in accordance with an embodiment of the present disclosure.

The figures are not intended to be drawn to scale. In the figures, each identical or nearly identical component that is illustrated in various figures is represented by a like numeral. For purposes of clarity, not every component may be labeled in every figure.

### DETAILED DESCRIPTION

Walking surfaces, especially those used in maritime and construction applications, are subject to extreme weather conditions such as sunlight exposure, torrential downpours, freezing and storm surges. Additionally, these surfaces are used in high traffic areas and thus experience daily wear and exposure to chemicals, such as fuels and heavy-duty cleaning solutions. Further, workers spend many hours a day standing on or walking over these surfaces while performing tasks that often expose them to many safety risks, like fall hazards, fatigue, and long-term joint problems. Commonly used materials for these surfaces are plywood and metal. Plywood is frequently used on construction scaffolding and is constantly exposed to weather extremes. Within less than one week after installation the surface can begin to warp and degrade, becoming an unsafe walking surface. It can also foster microbial growth such as mold and algae, rendering the surface extremely slippery. Further, due to constant replacement, plywood can be an expensive and wasteful option. Alternatively, metal becomes slippery when wet, is conductive, and can create an environment perfect for microbial growth. Accordingly, there is a need for an improved surface that is non-slip, impact absorbing, and can be used safely in exposed environments for many years with reduced degradation.

Thus, and in accordance with the embodiments of the present disclosure, a multi-use composite that reduces degradation, increases longevity of use, and provides additional safety and convenience benefits is disclosed. The disclosed multi-use portable composite can be applied in many applications such as the maritime and construction sectors, for use on ship decks, docks, and scaffolding. In one aspect, the multi-use composite contains three components; a substrate, a plurality of elastomeric granules, and an adhesive to bind the granules to one-another and to the substrate. The substrate provides a rigid base for the composite, and the elastomeric granules combined with the adhesive provides a non-slip surface layer. The composite can be movable or can be permanently adhered to surfaces such as concrete, asphalt, steel, aluminum and wood.

Although in many embodiments the non-slip surface is elastomeric, this elastomeric layer, including an adhesive, can add strength and rigidity to the substrate. Using the techniques described herein, the elastomeric layer can be securely adhered to the substrate to avoid the delamination and splintering that is prevalent in state-of-the-art materials. In various embodiments, the composite is notable for its non-porous properties such as its ability to shed water and absorb less than 1.5% as verified by ASTM D570, standard test method for water absorption of plastics. By excluding water from entering and being retained in and/or on the composite, the panel is not subject to the damage that can be caused by dirt and water when it enters the pores of other materials. For instance, when other materials may crack or delaminate as a result of water freezing in pores and/or interstitial spaces, the composites described herein can exclude that water entirely or almost entirely, resulting in a more durable system.

In some embodiments, sections of the surface material can include different colored indicia for safety or other information. These contrasting indicia can be composed of granules having the same composition, and they exhibit the same attributes. The composite panels can also include lights, load sensors, thermometers, accelerometers, fiber optics, electric cables and heaters. These features can be embedded in the composite to be unobtrusive. In some cases, connectors allow electric, plumbing or light circuits to be run through a series of panels. The panels can be, for example, either planar or slightly bowed, either in a concave or convex shape, providing for easy installation in tight spaces or precisely sized frames. A curved panel also provides a sloped surface to help shed water and other liquids. The panels can be constructed to maintain a curve under load or to flatten under use, such as when being walked upon. Numerous configurations and variations will be apparent in light of this disclosure.

### Example Structure

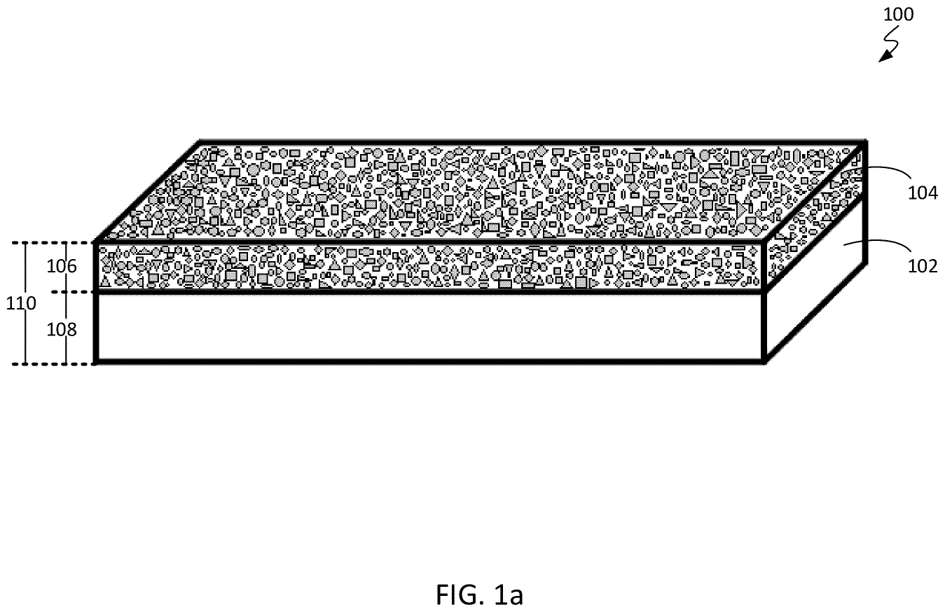

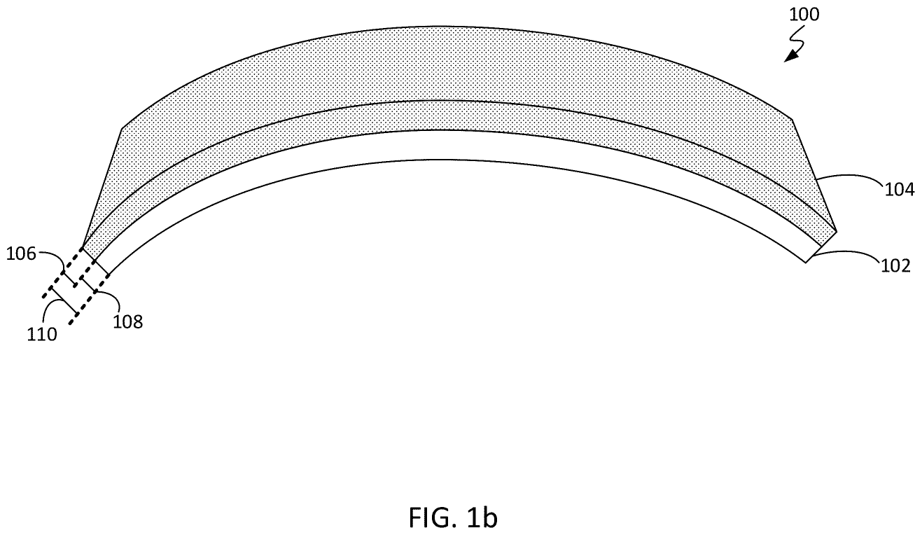

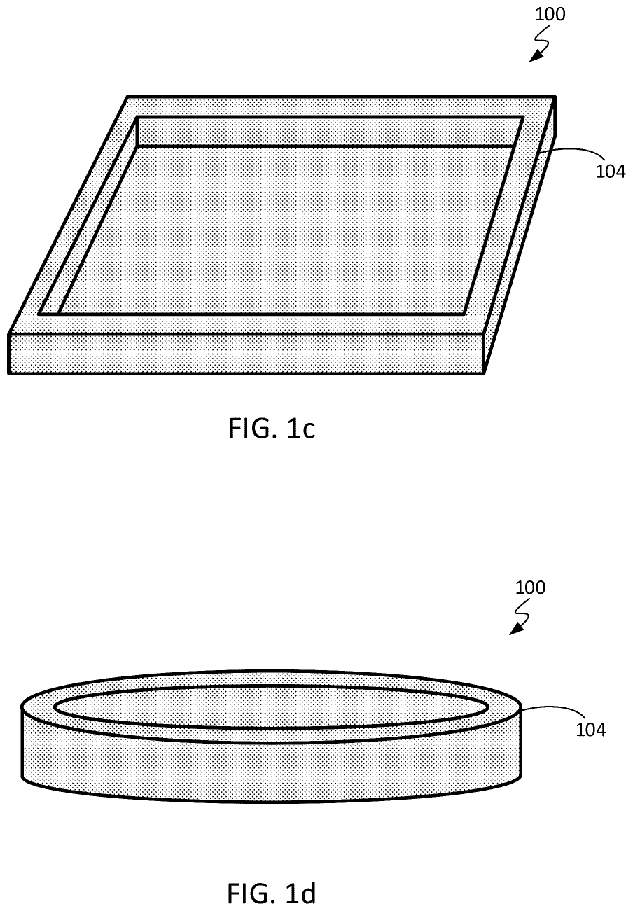

FIG. 1a is an isometric view of an example composite 100, according to an embodiment of the present disclosure. As shown in FIG. 1a, the composite 100 may include a substrate 102 and an elastomeric layer 104. The elastomeric layer 104 can be applied on the upward facing major surface of the substrate 102, providing a non-slip surface underfoot. Thus, elastomeric layer 104 can be said to be positioned on top of the substrate 102, as shown in FIG. 1a. In other embodiments, the composite may be positioned vertically. In a further set of cases the composite can be oriented horizontally with the elastomeric layer 104 facing down, such as in the case of a ceiling tile. In some embodiments, the elastomeric layer 104, can be applied to multiple surfaces of the substrate 102. For example, the elastomeric layer 104 may be applied to both the top and the bottom layer of the substrate 102 so the substrate 102 is sandwiched between the elastomeric layers 104. Alternatively, the elastomeric layer 104 may be applied on the top or bottom and on one or more edges of the substrate 102, so that fewer surfaces of the substrate 102 is exposed. Another example may include the substrate 102 being fully encased in the elastomeric layer 104, like the composites shown in FIGS. 1c and 1d.

The composite can be portable and in many embodiments is a planar panel, as shown in FIG. 1a. In planar form, the composite can be any useful shape, such as square, rectangular or polygonal. The composite can be curved to induce a camber that can help, for example, in shedding water, as shown in FIG. 1B. In some embodiments, the composite 100 is a rectangle and can have a length and width similar to that of common building materials, e.g., four feet by eight feet. In various embodiments, the composite 100 is a rectangle that has a length that is greater than one foot, greater than two feet, greater than four feet, or greater than eight feet. In some embodiments, the composite 100 can have a width that is greater than two feet, greater than four feet, greater than six feet, or greater than ten feet. In some embodiments, the composite 100 can have a length and width that is sized for a custom application. The composite can include an existing aluminum or steel structure as the substrate 102, as shown in FIGS. 1c and 1d.

In some embodiments, the composite 100 can be cut to size after it is formed. The edges of the composite may include features allowing adjoining sheets to be connected. These features can be molded into the composite or added in a secondary operation. In some embodiments, the edges of the finished composite 100 can be shaped using a secondary process such as routing, plaining, drilling or sawing. A variety of connectors can also be used, and the elastomeric layer can selfheal around and over fastener heads, leaving the heads covered and obscured after the fastener is installed.

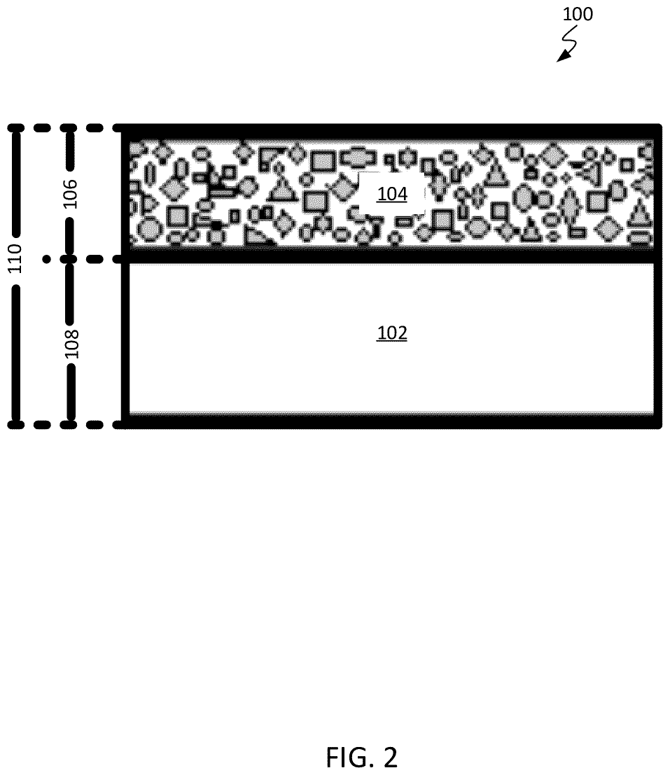

FIG. 2 is a cross-sectional view of the layers of the example composite 100 of FIG. 1a. The thickness of the substrate can vary greatly with the end use of the product. In various embodiments, substrate 102 can have a thickness 108 that is between 0.03 inches and 3.00 inches, between 0.10 and 0.50 inches, between 0.03 and 0.25 inches, and between 1.0 and 3.0 inches. Alternatively, in some embodiments, the substrate 102 can be less than 3.00 inches, less than 2.00 inches, less than 1.00 inch, less than 0.50 inch, less than 0.25 inch, less than 0.125 inch, less than 0.075 inch, or less than 0.05 inch.

In some embodiments, the elastomeric layer 104 may have a thickness 106, as shown in FIG. 1a of between 0.10 inches and 5.00 inches. Accordingly, in various embodiments, the thickness 106 may measure less than 5.00 inches, less than 4.00 inches, less than 3.00 inches, less than 2.00 inches, less than 1.50 inches, less than 1.00 inch, less than 0.50 inch, less than 0.3 inch, less than 0.2 inch or less than 0.10 inch. The thickness of the elastomeric layer across the substrate can be consistent and may vary by less than 10% or less than 50%.

In various embodiments the composite 100 may have a complete thickness 110, as shown in FIG. 2, between 0.30 inches and 3.00 inches. In some embodiments, the thickness 110 is less than 3.00 inches, less than 2.50 inches, less than 2.00 inches, less than 1.50 inches, less than 1.00 inches, or less than 0.50 inches. In some embodiments, the substrate 102 comprises between 10% and 75% of the total volume, or thickness, of the composite. In certain embodiments, the substrate 102 comprises between 15% and 70%, or between 25% and 50% of the volume or thickness of the composite 100. The substrate 102 can comprise less than 90%, less than 75%, less than 50%, less than 25%, or less than 10% of the volume or thickness of the composite 100. In the same and other embodiments, the substrate can comprise greater than 25%, greater than 50%, greater than 60% or greater than 70% of the volume of the composite. In some embodiments, the density of the substrate 102 can range from 15 to 30 pounds per cubic foot, 20 to 24 pounds per cubic foot, or 18 to 22 pounds per cubic foot. The density of the substrate may also be less than 30 pounds per cubic foot, less than 25 pounds per cubic foot, less than 20 pounds per cubic foot, or less than 15 pounds per cubic foot.

In some embodiments, the elastomeric layer 104 comprises between 10% and 90%, between 30% and 85%, or between 50% and 75% of the total volume of the composite 100. Alternatively, the elastomeric layer 104 may comprise less than 90%, less than 75%, less than 50%, less than 25% the total volume of the composite 100. In other cases, the elastomeric layer can account for greater than 10%, greater than 20%, greater than 30%, greater than 40%, greater than 50%, greater than 60%, greater than 70% or greater than 80% of the volume of the composite.

In some embodiments, where the substrate 102 comprises aluminum, the density of the substrate 102 can range from 2.0 to 3.0 grams per cubic centimeter, 2.5 to 2.7 grams per cubic centimeter, or 2.6 to 2.7 grams per cubic centimeter. The density of the substrate may also be less than 3.0 grams per cubic centimeter, less than 2.7 grams per cubic centimeter, or less than 2.5 grams per cubic centimeter.

In some embodiments, where the substrate 102 comprises steel, e.g. carbon steel or stainless steel, the density of the substrate 102 can range from 6.0 to 9.0 grams per cubic centimeter. For example, the density of the steel substrate can be less than 9.0 grams per cubic centimeter, less than 8.0 grams per cubic centimeter, or less than 7.0 grams per cubic centimeter.

In some embodiments, the composite 100 may have a density between 0.5 and 1.72 grams per cubic centimeter. In various embodiments, the density of the composite 100 can be less than 2, less than 1.75, less than 1.5, less than 1.25, less than 1.0, less than 0.9 or less than 0.75 grams per cubic centimeter. In the same and other embodiments, the density of the composition can be greater than 0.4, greater than 0.5, greater than 0.7, greater than 0.9, greater than 1.0, greater than 1.1, greater than 1.25, or greater than 1.5 grams per cubic centimeter. To illustrate a specific example, a composite panel may be 8 feet by 4 feet by 1.125 inches thick, with a 0.375 inches thick elastomeric layer, and a 0.75 inches thick substrate. Thus, the composite 100 in this example would comprise, by volume, 33% substrate and 67% elastomeric layer, and would have a density, depending on composition, between 0.69 and 1.39 grams per cubic cm.

In some embodiments, where the substrate comprises aluminum the composite 100 may have a density between 0.86 and 2.99 grams per cubic centimeter. In various embodiments, the density of the composite 100 can be less than 3.0, less than 2.5, less than 2.0, less than 1.5, or less than 1.0 grams per cubic centimeter. In the same or other embodiments, the density of the composition can be greater than 0.86, greater than 1.0, greater than 1.5, greater than 2.0, greater than 2.5, or greater than 2.75 grams per cubic centimeter.

In alternative embodiments, where the substrate comprises steel, e.g. a carbon steel or a stainless steel, the composite 100 may have a density between 0.85 and 8.80 grams per cubic centimeter. In various embodiments, the density of the composite 100 can be less than 8.5, less than 8.0, less than 7.0, less than 6.0, less than 5.0, less than 2.5, less than 1.25, or less than 1.0 grams per cubic centimeter. In the same and other embodiments, the density of the composition can be greater than 0.9, greater than 1.0, greater than 2.0, greater than 3.0, greater than 4.0, greater than 5.0, greater than 6.0, greater than 7.0, or greater than 2.75 grams per cubic centimeter.

The areal density of the composite sheets can be written as mass per unit area. Thus, the areal density of a composite depends not only on its composition but on its thickness. In different embodiments, the areal density can be, for example, greater than 0.5, greater than 1, greater than 1.5, greater than 2 or greater than 2.5 lb./sf. In the same and other embodiments, the areal density can be less than 3.5, less than 3, less than 2.5, less than 2.0, less than 1.5, less than 1, less than 0.75 or less than 0.5 lb./sf.

The composites can be manufactured to exhibit positive, negative or neutral buoyancy in fresh or saltwater. In many examples the composites are buoyant in both salt and fresh water and can be less than 90%, less than 80% or less than 70% the density of either salt or fresh water, depending on the application.

The composite can exhibit variable rigidity depending on its end use. In various embodiments, the composite should deflect less than 1 inch, less than 0.5 inch, or less than 0.25 inch when a 200 lb. weight is placed in the center of a 4×8 ft sheet that is supported only at opposite ends. The flexural modulus of the composite can be, for instance, greater than 500, greater than 750, greater than 1000, greater than 1250 or greater than 1500 MPa when tested using the 3-point bending test of ASTM D790. The flexural modulus can also be less than 1500, less than 1250, less than 1000, less than 750 or less than 500 MPa using the same test.

One way of characterizing the hardness of a polymeric surface is via ASTM D2583. This standard test method for indentation hardness of rigid plastics uses a Barcol impressor. In some embodiments, the composite may have an indentation hardness of less than 50, 45, 40, 35, 30 or 25 Barocl. In other embodiments, the composite may have an indentation hardness of greater than 25, 30, 35, 40, or 45 Barcol.

Substrate Composition—Polymer

In some embodiments, the substrate 102 includes a polymer. The polymers used in the substrate can include either natural or synthetic polymers, or both. Some natural polymeric materials include, hemp, shellac, amber wool, silk, and natural rubber. Synthetic polymers include, for example, thermoplastics, thermosets, and elastomers. Specific examples include acrylics, urethanes, polyesters, epoxies, acrylamides, polyethylene, polypropylene, polystyrene, polyvinyl chloride, synthetic rubber, phenol formaldehyde resin, neoprene, nylon, polyacrylonitrile, PVB, silicone and ABS.

In some embodiments, the substrate 102 consists of, consists essentially of, or comprises, a polymeric foam, also referred to as a cellular polymer. Polymeric foam is a polymer that includes trapped bubbles or microbubbles. Some example polymers that can be foamed include polyurethane, polychloroprene, polyvinyl chloride, polyethylene foam, polystyrene, polypropylene, polyimide foam, nitrile rubber, low-density polyethylene, and ethylene-vinyl acetate. Polymeric foams provide an excellent substrate material for marine applications as they are not corroded by salt-water, and because they have excellent buoyancy due to the low density provided by the closed cells.

In specific embodiments, substrate 102 is made of a polyurethane. Polyurethane is a polymer composed of organic units joined by carbamate links and is produced by reacting one or more polyols with one or more isocyanates. In some embodiments, polyurethanes are thermoset polymers, thermoplastic polyurethanes moisture cure polymers, radiation cure polymers or heat cure polymers.

The type of isocyanates and polyols used can affect the polymer's properties. For example, those with higher amounts of crosslinking create a tougher, more rigid polymer. Polyols used in rigid polyurethanes have lower molecular weights than those used in flexible polyurethanes. The polyols used herein to make a rigid material have a molecular weight less than 1000 Da, less than 750 Da, less than 500 Da, less than 250 Da, or less than 100 Da. Alternatively, polyols used to make more flexible embodiments have molecular weights greater than 1000 Da, greater than 2000 Da, greater than 3000 Da, greater than 5000 Da, or greater than 6000 Da.

Making of polyurethane foam requires the formation or addition of a gas at the same time as the cross-linking. In some embodiments the gas is generated by reacting isocyanate with water and in other embodiments by vaporizing volatile liquids, typically via the heat generated by the polymerization. During the urethane polymerization, an unstable carbamic acid is formed and then decomposed into carbon dioxide and an amine. Then a substituted urea is formed when the amine reacts with more isocyanate. Because urea is not very soluble, the reaction mixture, in some embodiments, forms “hard segment” phases which consist of polyurea. The concentration and organization of this polyurea can impact the strength and rigidity of the polyurethane foam.

In some embodiments, the substrate 102 includes a rigid polyurethane foam. A polyurethane foam may be considered rigid if the compressive stress value is at least 75 kPa, at least 100 kPa, or at least 125 kPa. During this rigid foam's production, a specialty trimerization catalyst can be used that forms cyclic structures within the foam matrix, giving harder, more thermally stable structures.

In some embodiments the polymer substrate 102 may be reinforced. The substrate 102 can be reinforced with, for example, glass fibers, carbon fibers, or nylon fibers. The specific energy of absorption in a composite structure can be increased by dispersing the reinforcement material through the polymer matrix. Further, reinforced polyurethane foam has a higher load bearing capacity than an un-reinforced alternative made of the same polyurethane material. Additionally, reinforced polyurethane foam typically retains the energy absorption properties of the un-reinforced alternative. Therefore, using reinforced polymeric foam for the substrate 102 can provide good vibration damping, increased stiffness, and higher energy absorption than alternative materials.

The substrate may also include fillers to, for example, reduce density, provide color, improve wetting, increase electrical conductivity and adjust viscosity. These fillers can include glass microspheres, graphite powder, carbon black, talc, clay, calcium carbonate, silica, metal oxides, and pigments. Individual fillers and the sum of all fillers may comprise greater than 0.1%, 0.5% or 1.0% by weight of the substrate. In some cases, the substrate is void of fillers. Additional materials in the polymeric substrate can include process oils, catalysts, accelerators, foaming agents, foaming aids, desiccants, dispersants and emulsifiers. In some embodiments, the elastomeric granules include a tack-neutral additive. A “tack-neutral additive” is an additive which has no inhibiting effect upon the surface tack of crosslinked products produced by vulcanizing the composition of the elastomeric granules in the presence of oxygen.

Using a fiberglass reinforced cellular polymer can result in a substrate 102 that is typically 10-60% lighter than similarly dimensioned plywood or OSB. In various embodiments, the substrate can be less than 90%, less than 80%, less than 70%, less than 60% or less than 50% the density of an equivalently sized sheet of plywood.

The wettability of the surface of the substrate can be represented by its surface energy. In some embodiments, the surface energy of the substrate 102 may be less than 1200 mJ/m², between 250-1100 mJ/m², between 35-50 mJ/m², or between 15-35 mJ/m². In other embodiments, the surface energy of the substrate 102 may be at least 30 mJ/m², at least 45 mJ/m², at least 50 mJ/m², at least 500 mJ/m², or at least 1200 mJ/m².

In some embodiments the substrate is a homogenous material. A homogenous structure is one which is uniform in composition. In other cases, the substrate can vary in structure. For example, it may contain an increased or reduced concentration of reinforcement around the edges or in the central portion. Pigment concentration may also vary throughout the substrate panel.

Substrate Composition—Aluminum

In some embodiments, the substrate 102 includes a metal such as aluminum. In some embodiments, the substrate may include an aluminum alloy. In some embodiments, the aluminum alloy can include aluminum alloyed with one or more of magnesium, chromium, manganese, iron, silicon, zinc, titanium, chromium, and/or copper. Example aluminum alloys include 5052, 5083, 5086, 5454, 5456, 5754, 6061, 6063, and 7075.

In some embodiments, the aluminum substrate may include greater than 90%, greater than 95%, greater than 97%, or greater than 98% aluminum by weight. The aluminum substrate may also comprise less than 100%, less than 98%, less than 97%, or less than 95% aluminum by weight. In the same or alternative embodiments, the aluminum substrate may include less than 4%, less than 3%, less than 2.5% or less than 1%, or greater than 0.5%, greater than 1%, greater than 2%, greater than 3%, or greater than 4% magnesium. In the same or alternative embodiments, the aluminum substrate may include less than 0.35%, less than 0.25%, less than 0.15%, or less than 0.10%, or greater than 0.10%, greater than 0.15%, greater than 0.25%, or greater than 0.35% chromium. In the same or alternative embodiments, the aluminum substrate may include less than 1.00%, less than 0.75%, less than 0.5%, less than 0.25%, or less than 0.10%, or greater than 0.10%, greater than 0.25%, greater than 0.5%, greater than 0.75%, or greater than 1.00% manganese. In the same or alternative embodiments, the aluminum substrate may include less than 0.70%, less than 0.50%, or less than 0.10%, or alternatively, greater than 0.10%, greater than 0.50%, or greater than 0.70% silicon. In the same or alternative embodiments, the aluminum substrate may include less than 3.0%, less than 2.0%, less than 1.0%, less than 0.25%, or greater than 0.25%, greater than 1.0%, greater than 2.0%, or greater than 3.0% copper. In the same or alternative embodiments, the aluminum substrate may include less than 10%, less than 7.0%, less than 5.0%, or less than 1.0%, or greater than 1.0%, greater than 5.0%, greater than 7.0%, or greater than 10% zinc.

In some embodiments, the substrate can have a tensile strength of less than 50000 psi, less than 45000 psi, less than 40000 psi, or less than 35000 psi. In the same or alternative embodiments, the aluminum substrate can have a tensile strength of greater than 30000 psi, greater than 35000 psi, greater than 40000 psi, or great than 45000 psi. In some embodiments, the aluminum substrate has an elongation at break of greater than 10%, greater than 15%, greater than 20%, or greater than 30%. Similarly, the aluminum substrate may have an elongation at break of less than 35%, less than 25%, less than 20%, or less than 15%. The substrate, in some embodiments, can have a modulus of elasticity of greater than 65 GPa, greater than 68 GPa, greater than 70 GPa, or greater than 71 GPa. In the same or alternative embodiments, the aluminum substrate may have a modulus of elasticity of less than 71 GPa, less than 70 GPa, less than 68 GPa, or less than 65 GPa. In some embodiments, the aluminum substrate has a specific heat capacity of less than 1000 J/kg*K, less than 900 J/kg*K, less than 850 J/kg*K, less than 800 J/kg*K, or less than 750 J/kg*K. In alternative or the same embodiments, the aluminum substrate has a specific heat capacity of greater than 750 J/kg*K, greater than 800 J/kg*K, greater than 850 J/kg*K, greater than 900 J/kg*K, or greater than 1000 J/kg*K. In some embodiments, the aluminum substrate may have a volume resistivity between 25nΩm-75nΩm. In the same or alternative embodiments, the aluminum substrate may have a volume resistivity less than 75nΩm, less than 60nΩm, less than 55nΩm, less than 50nΩm, less than 40nΩm, or less than 30nΩm. In the same or alternative embodiments, the aluminum substrate may have a volume resistivity greater than 30nΩm, greater than 40nΩm, greater than 50nΩm, greater than 55nΩm, or greater than 60nΩm.

Steel Substrate Composition:

In some embodiments, the substrate 102 may include steel, e.g., carbon steel or stainless steel. In some embodiments, the steel substrate can be a martensite steel and can be, for instance, A36, DH36, EH36, or HY80 carbon steel. In alternative embodiments, the steel substrate can be 304 or 316 stainless steel. In some embodiments, the substrate can include, in varying compositions, carbon, chromium, iron, manganese, nickel, phosphorus, sulfur, silicon, copper, molybdenum, niobium, and/or vanadium.

Carbon Steel Substrate:

In some embodiments, the substrate may be carbon steel and may include greater than 90%, greater than 95%, greater than 97%, or greater than 98% iron. The carbon steel substrate may comprise less than 100%, less than 98%, less than 97%, or less than 95% iron. In the same or alternative embodiments, the carbon steel substrate may include less than 2%, less than 1.75%, less than 1.5%, or less than 1%, or greater than 1%, greater than 1.5%, greater than 1.75%, or greater than 2% manganese. In the same or alternative embodiments, the carbon steel substrate may include less than 2%, less than 1.5%, less than 1%, or less than 0.5%, or greater than 0.5%, greater than 1%, greater than 1.5%, greater than 2% chromium. In the same or alternative embodiments, the carbon steel substrate may include less than 1.00%, less than 0.75%, less than 0.5%, less than 0.25%, or less than 0.10%, or greater than 0.10%, greater than 0.25%, greater than 0.5%, greater than 0.75%, or greater than 1.00% carbon. In the same or alternative embodiments, the carbon steel substrate may include less than 0.70%, less than 0.50%, or less than 0.10%, or greater than 0.10%, greater than 0.50%, or greater than 0.70% silicon. In the same or alternative embodiments, the carbon steel substrate may include less than 1.0%, less than 0.75%, less than 0.5%, or less than 0.25%, or greater than 0.25%, greater than 0.5%, greater than 0.75%, or greater than 1.0% copper. In the same or alternative embodiments, the carbon steel substrate may include less than 5%, less than 1%, less than 0.75%, or less than 0.5%, or greater than 0.5%, greater than 0.75%, greater than 1%, or greater than 5% nickle. In the same or alternative embodiments, the carbon steel substrate may include less than 1%, less than 0.75%, less than 0.5%, or less than 0.25%, or greater than 0.25%, greater than 0.5%, greater than 0.75%, or greater than 1% molybdenum.

In some embodiments, the carbon steel substrate can have a tensile strength of less than 100000 psi, less than 90000 psi, less than 80000 psi, less than 70000 psi, or less than 50000 psi. In the same or alternative embodiments, the carbon steel substrate may comprise a tensile strength of greater than 50000 psi, greater than 70000 psi, greater than 80000 psi, greater than 90000 psi, or greater than 100000 psi. In some embodiments, the carbon steel substrate has an elongation at break of greater than 10%, greater than 15%, greater than 20%, or greater than 30%. Similarly, the carbon steel substrate may have an elongation at break of less than 35%, less than 25%, less than 20%, or less than 15%. The carbon steel substrate, in some embodiments, can have a modulus of elasticity of greater than 75 GPa, greater than 100 GPa, greater than 150 GPa, or greater than 200 GPa. In the same or alternative embodiments, the carbon steel substrate may have a modulus of elasticity of less than 200 GPa, less than 150 GPa, less than 100 GPa, or less than 75 GPa. In some embodiments, the carbon steel substrate may have a volume resistivity less than 200μΩm, less than 175μΩm, less than 150μΩm, less than 125μΩm, less than 100μΩm, or less than 75μΩm. In the same or alternative embodiments, the carbon steel substrate may have a volume resistivity of greater than 75μΩm, greater than 100μΩm, greater than 125μΩm, greater than 150μΩm, greater than 175μΩm, or greater than 200μΩm.

Stainless Steel Substrate:

In some embodiments, the substrate may be stainless steel. In these embodiments, the substrate may comprise greater than 70%, greater than 75%, greater than 80%, or greater than 90% iron. In the same or alternative embodiments, substrate may comprise less than 90%, less than 80%, less than 75%, or less than 70% iron. In the same or alternative embodiments, the stainless steel substrate may include less than 25%, less than 20%, less than 15%, or less than 10%, or greater than 10%, greater than 15%, greater than 20%, or greater than 25% chromium. In the same or alternative embodiments, the stainless steel substrate may include less than 20%, less than 15%, less than 10%, or less than 5%, or greater than 5%, greater than 10%, greater than 15%, greater than 20% nickel. In the same or alternative embodiments, the stainless steel substrate may include less than 10%, less than 5%, less than 4%, less than 3%, or less than 1%, or greater than 1%, greater than 3%, greater than 4%, greater than 5%, or greater than 10% molybdenum. In the same or alternative embodiments, the stainless steel substrate may comprise less than 1% or greater than 0.05% carbon, less than 1%, or greater than 0.05% silicon, less than 3% or greater than 1% manganese, less than 1% or greater than 0.05% phosphorus, less than 1%, or greater than 0.05% nitrogen, and/or less than 1%, or greater than 0.05% sulfur.

In some embodiments, the stainless steel substrate can have a tensile strength of less than 100000 psi, less than 80000 psi, less than 75000 psi, less than 60000 psi, less than 50000 psi, or less than 40000 psi. In the same or alternative embodiments, the stainless steel substrate may have a tensile strength of greater than 40000 psi, greater than 50000 psi, greater than 60000 psi, greater than 75000 psi, or greater than 80000 psi. In some embodiments, the stainless steel substrate has an elongation at break of greater than 20%, greater than 25%, greater than 30%, or greater than 50%. Similarly, the stainless steel substrate may have an elongation at break of less than 60%, less than 50%, less than 35%, or less than 25%. The stainless steel substrate, in some embodiments, can have a modulus of elasticity of greater than 75 GPa, greater than 100 GPa, greater than 150 GPa, or greater than 200 GPa. In the same or alternative embodiments, the stainless steel substrate may have a modulus of elasticity of less than 200 Gpa, less than 150 GPa, less than 100 GPa, or less than 75 GPa. In some embodiments, the stainless steel substrate may have a volume resistivity less than 50μΩm, less than 30μΩm, less than 25μΩm, less than 10μΩm, or less than 5μΩm. In the same, or alternatively embodiments, the stainless steel substrate may have a volume resistivity of greater than 5μΩm, greater than 10μΩm, greater than 20μΩm, greater than 25μΩm, greater than 30μΩm, or greater than 40μΩm.

Elastomeric Layer Composition:

As previously described and shown in FIG. 1a, in some embodiments, an elastomeric layer 104 is formed on top of the substrate 102. In some embodiments, the elastomeric layer 104 may comprise a plurality of elastomeric granules bonded into a common mass by an adhesive. The granules can be permanently bonded to each other and the entire elastomeric layer 104 can be permanently adhered to the substrate surface. While the elastomeric layer 104 can provide traction, cushioning and protection against the elements, it can also alter the rigidity of the substrate. In some cases, the elastomeric layer can increase the rigidity of the substrate by greater than 10%, greater than 20% or greater than 30%. The elastomeric layer can be flexible and can be stretched as well as compressed, so it conforms to the substrate when the composite is flexed either inwardly or outwardly. The elastomeric layer can have a thermal coefficient of expansion that is close to that of the underlying substrate. For example, between −40 and 50 degrees Celsius, the coefficient of thermal expansion between the elastomeric layer and the substrate can vary, in certain embodiments, by less than 50%, less than 20% or less than 10%. In some embodiments, according to ASTM D696, the coefficient of thermal expansion is at least −5.5×10⁻⁶ in/in.

In some embodiments, the elastomeric layer 104 comprises adhesive at up to 20% by weight, up to 15% by weight, or up to 10% by weight. For example, in specific embodiments the elastomeric layer may comprise 20% by weight adhesive to 80% by weight elastomeric granules, 15% by weight adhesive to 85% by weight elastomeric granules, 10% by weight adhesive to 90% by weight granules, or 5% by weight adhesive to 95% by weight granules. Further, the adhesive and granules can be mixed at a weight ratio of greater than 1:5 greater than 1:6 greater than 1:7 greater than 1:8 greater than 1:9 or greater than 1:10. In the same or alternative embodiments the adhesive and elastomeric granules mix ration may be less than 1:10, less than 1:9, less than 1:8, less than 1:7, less than 1:6, or less than 1:5.

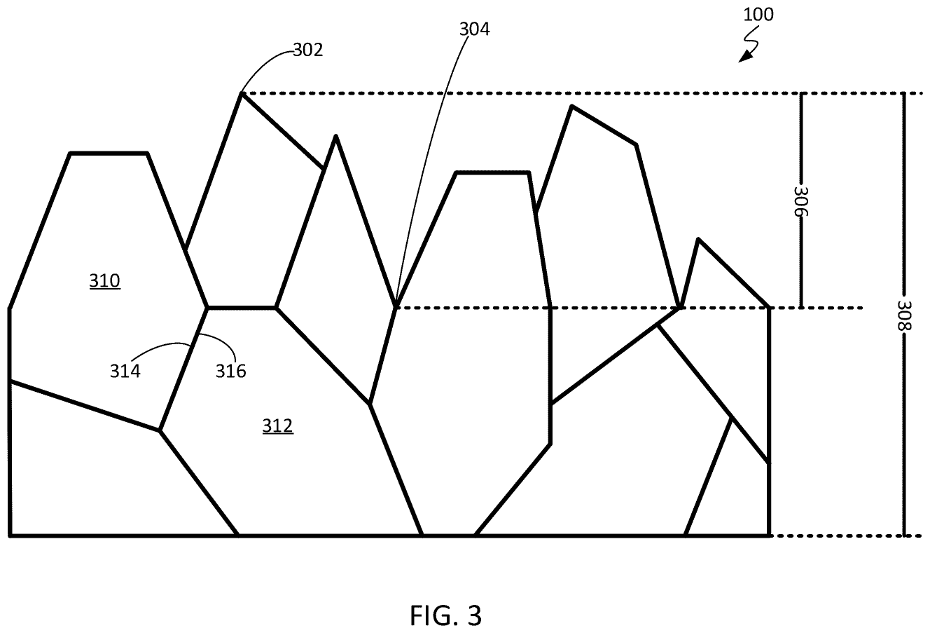

In some embodiments, the surface of the elastomeric layer comprises a series of peaks and valleys due, in part, to the irregular shapes of the elastomeric granules. FIG. 3 depicts the profile of an embodiment of an elastomeric layer 104. The roughness provided by these peaks and valleys can be measured by comparing the thickness of the elastomeric layer 104 measured at a peak 302 to the thickness of the elastomeric layer 104 measured at a valley 304. In many embodiments the difference between the height of the highest peak in a 1 cm 2 area and of the lowest valley 304 in the same area may be less than 10%, less than 8%, less than 6%, less than 4% or less than 2% of the thickness of the elastomeric layer 308. The thickness of the elastomeric layer 308 is determined by measuring the distance between the top of the substrate and a second, planar piece of substrate that is rested temporarily on the top surface of the elastomeric layer 104. The rise of the highest peak above the lowest valley in a square centimeter sample can also be measured absolutely 306 and can be, for example, greater than 0.2, 0.5, 1, 2, 3, 4 or 5 mm. In other cases, this difference may be less than 5, less than 4, less than 3, less than 2, less than 1, less than 0.5, less than 0.2 or less than 0.1 mm.

In some embodiments, as shown in FIG. 3, the elastomeric granules, such as 310 and 312, each have a plurality of planar surfaces, such as 314 and 316. By joining these essentially planar surfaces 314 and 316 together, a high adhesion level between the elastomeric granules is achieved. A significant portion of the surface of one granule can be adhered to a significant portion of the surface of an adjacent granule. This provides for much greater shear strength in comparison to other systems joining particles together where the junctions are primarily point to surface or edge to surface rather than surface to surface. The strength of adhesion between granules is a function of, in part, the area of one granule in contact with the area of an adjacent granule. It is believed that greater the surface contact between granules leads to an increase in tensile strength of the layer as well as of the composite. When arranged, cube shaped granules might provide the best surface to surface adhesion between particles, but the use of cubes would provide much less traction on the elastomeric surface compared to irregularly shaped granules. It has been found for some embodiments that the best combination of traction and adhesion can be achieved using granules that are irregular, but still contain a significant percentage of planar surfaces of large surface area. Generally, the fewer the planar surfaces on the granule, the larger the area of each of the surfaces. In some embodiments, the granules average fewer than 15, fewer than 10, or fewer than 8 distinct planar surfaces. Another metric for measuring the effective surface area is the percent of planar surfaces of a specific minimum size in relation to the total surface area of the granule. For instance, a cube's planar surfaces of at least 5% of the total each would account for 100% of the total surface area of the granule. A sphere would have total planar surfaces equal to 0% of the total surface area. For instance, in some embodiments, the sum of the essentially planar surfaces of greater than 5% of the total surface area each accounts for greater than 50%, greater than 60%, greater than 70%, greater than 80% or greater than 90% of the total surface area of the granule.

It can also be important to maximize the surface area of granules that are in planar contact (with adhesive in between) with the substrate surface. In some embodiments, the surfaces of granules that are parallel to and in contact (except for a thin layer of adhesive) with, the substrate surface account for greater than 30%, greater than 50%, greater than 70% or greater than 80% of the total area of the substrate surface. This results in strong adhesion between the elastomeric layer and the substrate. In various embodiments, the maximum tensile stress needed to detach/unstick the elastomeric surface 104 from the substrate 102 is at least 15,000 psi, at least 20,000 psi, at least 25,000 psi, at least 30,000 psi, at least 35,000 psi, or greater than 35,000 psi. These tensile strengths are based on ASTM D638, standard test method for tensile properties of plastics.

The elastomeric layer provides a high-traction, non-slip surface. The wet dynamic coefficient of friction (DCOF) of the surface of the non-slip layer is in excess of approximately 0.95±0.05, which is about five times more slip resistant than untreated wood, metal, or other traditional composites. Thus, the traction level of the composite meets and even exceeds the American Disabilities Act and Occupational Safety and Health standards.

Elastomeric Granule Composition:

Many environments in which the composite surfaces are used are exposed to a wide range of temperatures. Therefore, the elastomeric granules described herein a specifically selected for exhibiting high and low temperature tolerance. In some embodiments the elastomeric granules have a maximum service temperature of greater than or equal to 350 degrees F., greater than 300 degrees F., greater than 250 degrees F., greater than 200 degrees F., or greater than 100 degrees F. In some embodiments, the elastomeric granules have a minimum service temperature of less than or equal to −60 degrees F., less than −40 degrees F., less than −20 degrees F., less than −10 degrees F., or less than 0 degrees F. In many applications, such as ship decks, docks and construction scaffolding, heavy equipment can be dropped suddenly onto the surface. At low temperatures, some elastomers can fracture when stress is applied. The elastomeric granules used herein are designed to withstand impact at low temperatures. Brittle failure, also referred to as brittle fracture, refers to the breakage of the elastomeric granules due to a sudden fracture under tensile stress. In some embodiments, the elastomeric granules resist brittle failures at temperatures as low as −90 degrees F., −75 degrees F., −50 degrees F., or −25 degrees F.

The elastomeric granules used herein can be produced from a variety of rubber compounds having different compounding properties, such as Mooney viscosity. In some embodiments the elastomer has a Mooney viscosity between 30 to 110, 50 to 100, or 60 to 90. The Mooney viscosity may be greater than 30, greater than 50, greater than 70, greater than 90, greater than 110. In other embodiments, the Mooney viscosity may be less than 110, less than 90, less than 70, less than 50, or less than 30.

Different molecular weights can lead to various desirable properties, such as resilience and rigidity. In some embodiments, the elastomeric granules are composed of polymer units having molecular weights of 50,000 to 1,000,000; 80,000 to 750,000; or 100,000 to 720,000. In some embodiments, the molecular weight may be greater than 50,000, greater than 75,000, greater than 100,000, greater than 250,000, greater than 500,000, or greater than 750,000. In some embodiments the molecular weight may be less than 1,000,000, less than 750,000, less than 500,000, less than 250,000, less than 100,000, or less than 50,000.

Elongation is an important test to characterize polymers, particularly in applications where the material is used in a high friction environment. In some embodiments, the elastomeric granules are elastic with a 400% to 600% elongation, 500-600% elongation, or greater than 600% elongation to break. In other embodiments the elastomeric granules can be flexible but exhibit less than 600% elongation, less than 500% elongation, or less than 400% elongation. In other embodiments the elastomeric granules are elastic to greater than 200%, greater than 300%, greater than 400%, greater than 500% or greater than 600% elongation.

Tensile strength of the material can provide a good indication as to its durability under extreme conditions. In some embodiments, the tensile strength of the granules ranges from 500 psi to 2500 psi, 1000 psi to 2500 psi, or 1500 psi to 2250 psi. The range of tensile strength may be greater than 500 psi, greater than 1000 psi, greater than 1500 psi, greater than 2000 psi, or greater than 2500 psi. The tensile strength range may be less than 2500 psi, less than 2000 psi, less than 1500 psi, or less than 1000 psi.

In various embodiments, the hardness of the elastomeric granules can be selected to match a particular application. For example, when the composite is used as a walking surface, the material selected can have a low hardness to provide comfort and fatigue reduction among those using the surface. In some embodiments, the elastomeric granules can have a hardness on a Duro A scale of 30 to 90, 30 to 75, or 45 to 50. In other embodiments, the elastomeric granules have a hardness on the Duro A scale or less than 90, less than 75, or less than 50. In alternative embodiments, the elastomeric granules may have a hardness on the Duro A scale of greater than 30 or greater than 45, or greater than 50.

In some embodiments, the elastomeric granules are between 0.5 mm and 6.0 mm in average size, alternatively between 0.5 mm and 4 mm, or between 1 mm and 3 mm. Granules may be sized less than 6 mm, less than 5 mm, less than 4 mm, less than 3 mm, or less than 1 mm. Granules also may be sized greater than 0.5 mm, greater than 1.0 mm, or greater than 2.0 mm. Granule sizes are measured using sieve analysis. Sieve analysis separates granules through a wire mesh sieve with different aperture sizes. The smallest sieve aperture that a granule can pass through is determined to be the granule's size. A No. 35 to a No. 3.5 sieve may be used to obtain elastomeric granules between 0.5 mm to 5.6 mm respectively. To obtain elastomeric granules between 0.5 mm and 4 mm a No. 35 to a No. 5 sieve may be used respectively. To obtain elastomeric granules between 1.0 mm and 3 mm a No. 18 to No. 7 sieve may be used respectively. In some cases, it is beneficial to have consistency in granular sizes. The less variation in size of granules applied to the surface the less variability of surface properties across the composite 100. In some embodiments, the standard deviation of the size of the elastomeric granules used in production of the composite 100 is less than 1 mm, alternatively less than 0.5 mm, or less than 0.2 mm. In other cases, it may be desirable to have variable sizes of granules in a common composite. In these cases, the standard deviation in sizes may be greater than 0.2 mm, greater than 0.5 mm, greater than 1 mm, greater than 2 mm or greater than 3 mm.

Elastomeric granules can be made from natural or synthetic materials. In some embodiments the elastomeric granules may include a synthetic rubber material. Some synthetic rubbers are less sensitive to ozone cracking than natural rubbers which makes them a preferred material in applications in extreme weather conditions. Synthetic rubbers include, for example, EPDM, fluorocarbon, polyisobutylene, thermoplastic elastomers, polyurethanes, silicone rubber, chlorosulfonated polyethylene (CSPE), polyethylene, and polybutadiene.

In some embodiments, the elastomeric granules may consist of, consist essentially of, or comprise EPDM rubber. EPDM is made from ethylene, propylene, and a diene comonomer that enables crosslinking via sulfur vulcanization. Synthetic rubbers, with saturated polymer backbones, such as EPDM, are more resistant to heat, light, and ozone than natural rubber. This resistance to light and ozone makes it ideal for applications in exposed conditions. EPDM is very flexible, with up to 675% elongation, up to 650% elongation, or up to 600% elongation and a tensile strength range of 500 psi to 2500 psi. Additionally, EPDM can range from 30-90 on the Shore A hardness scale.

Adhesive Composition:

The adhesive used to adhere the granules to the substrate can also bond the elastomeric granules to each other. The adhesive can provide rigidity and hardness to the elastomeric surface. It can be colorless or pigmented and can be transparent or translucent. It is compatible with both the substrate and the granules. In some cases, the same adhesive can be used to adhere the composite panel to an underlying surface, such as concrete, metal or wood.

In some embodiments, the adhesive used in production of the composite 100 is a polyurethane, and in some cases is a polyurethane made using an aliphatic diisocyanate polymer. The aliphatic diisocyanate can be a straight chain aliphatic polyurethane. The adhesive may include a solvent, accelerators, catalysts and other additives. In a specific embodiment the adhesive material comprises 60 to 70% polymer, 36 to 46% cyclohexane, 1 to 3% stannane, and 1 to 3% morpholine.

In many cases, it is important for the elastomeric granules to be homogeneously mixed with the adhesive prior to curing. The proper adhesive viscosity can aid in forming a favorable mixture. In some embodiments, the uncured adhesive has a viscosity between 2400 mPa-s and 40000 mPa-s, or 30000 to 40000 mPa-s. In some embodiments, the viscosity is greater than 2400 mPa-s, greater than 10000 mPa-s, or greater than 30000 mPa-s. In some embodiments, the viscosity is less than 50000 mPa-s, less than 40000 mPa-s, less than 30000 mPa-s, or less than 10000 mPa-s. Further, in some embodiments the molecular weight of the adhesive is between 1000 and 6000 Da. In some embodiments, the molecular weight is greater than 1000 Da, greater than 3000 Da, or greater than 5000 Da.

In some embodiments, the adhesive material can withstand temperatures up to 400 degrees F., up to 300 degrees F., or up to 200 degrees F. Failure is determined to be when the adhered particles fall off the substrate after exposure to high temperature for one hour.

The cured adhesive can be hydrophilic or hydrophobic. In many applications a hydrophobic adhesive is preferred because it helps to shed water from the surface. In some embodiments, the surface energy of the adhesive may be between 15 and 50 mJ/m², between 15 and 30 mJ/m², between 30 and 45 mJ/m², or between 35 and 50 mJ/m². Alternatively, the surface energy of the adhesive is less than 50 mJ/m², less than 35 mJ/m², less than 30 mJ/m², or less than 25 mJ/m².

In some embodiments, an additive incorporated in the adhesive material to change the mechanical properties of the adhesive. For example, wood flour, silica, and microbeads increase viscosity, microfibers of glass, carbon, and basalt increase strength in compression and tension and rigidity of the epoxy, graphite, aluminum, and copper increase degradation from UV light, and copper, gold, zinc and silver increase thermal conductivity, degradation from UV light, and have additional antimicrobial properties.

As previously stated, in some embodiments copper or copper alloys are added to the adhesive, particularly to create an antimicrobial surface. Copper particles may be added to the adhesive in weight ratios of, for example, more than 1%, 2%, 5%, 10%, 15%, or 20%. The mean diameter of the copper particle may be greater than or less than 60 nm, 80 nm, 1 mm, or 5 mm. Adding copper particles can create a surface that kills greater than 50%, 75%, or 99% of bacteria within two hours of contact. Other biocides such as silver and organic biocides may also be incorporated.

Additional Composite Properties:

In some embodiments, the composite is configured to be UV resistant. This means that in the presence of UV rays, i.e. applications in outdoor environments, the surface is less prone to degrade or discolor over time. The composite surface may be resistant to UV in the 250-320 nm range. A material is considered to be resistant to UV rays if it increases the life of the material by a factor of 10× compared to a non-resistant equivalent material (no additive).

In some embodiments, the surface of the composite 100 has a solar reflectivity index (SRI) of 10 or greater, preferably 29 or greater, and more preferably 34 or greater. SRI is a numerical expression of a surface's ability to reject solar heat. Alternatively stated, the SRI is the measure of a constructed surface's ability to reflect solar heat as shown by a temperature rise. The SRI is a combination of the total solar reflectance and emissivity value of a surface. For example, a standard black surface with a reflectivity of 5% and emittance of 90% has an SRI of 0, a standard white surface with reflectivity of 80% and emittance of 90% has an index of 100.

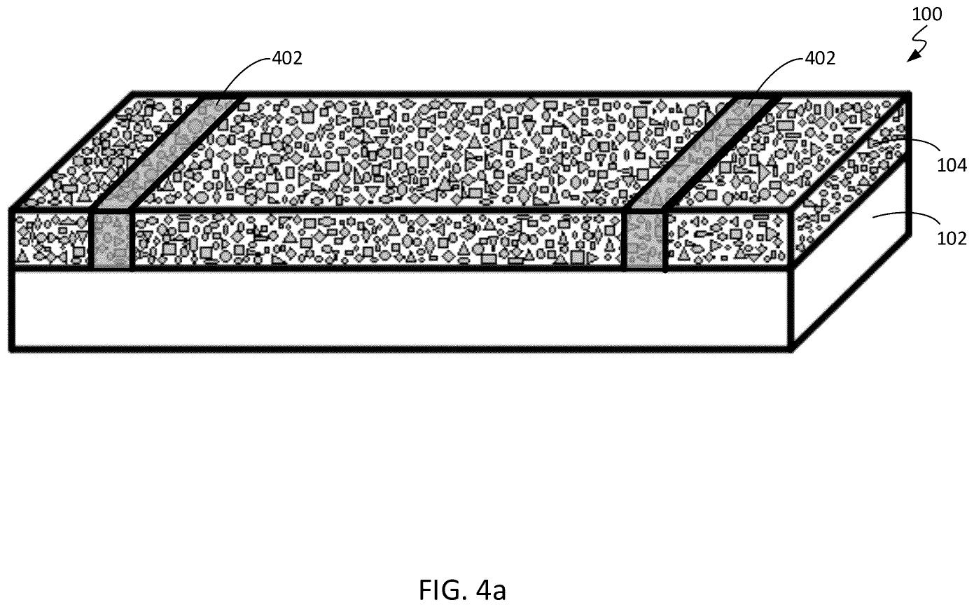

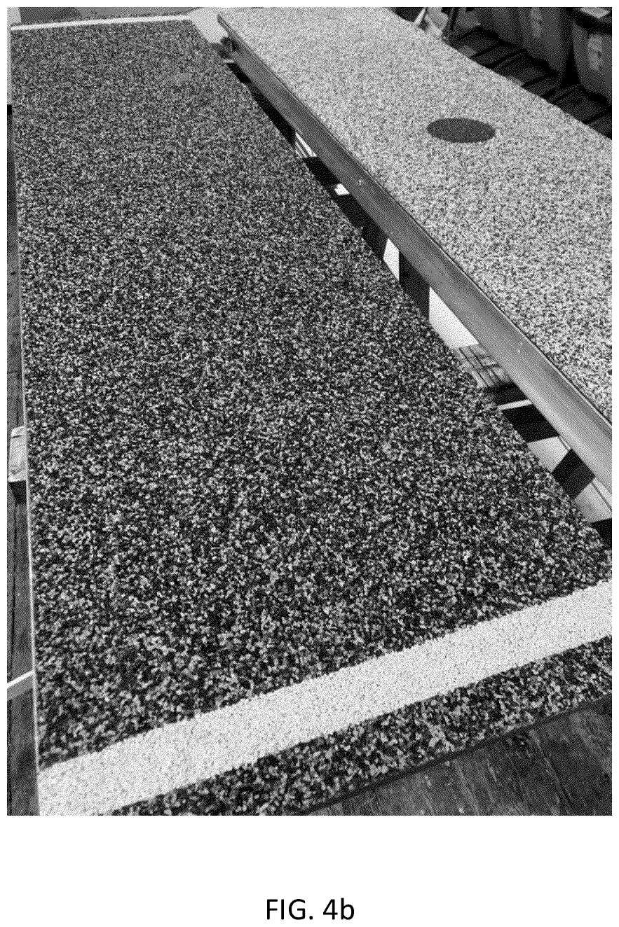

As shown in FIGS. 4a and 4b, in some embodiments, the multi-use composite 100 further includes embedded indicia 402 (patterns) in the surface of the composite 100. These indicia 402 may include safety markings, logos, information, or decorative patterns. One way these indicia 402 are embedded is by using granules with a different appearance than the bulk of the granules. This appearance can be, for example, color, reflectivity, fluorescence or luminosity. These colored granules can exhibit the same general properties as the plurality of granules. The colored granules that make up the pattern 402 can be adhered to the substrate 102 using the same adhesive material described for binding the uncolored elastomeric granules. Embedded granules create indicia 402 that lasts longer in exposed environments than traditional surface treatment methods such as adhering or painting safety markings or logos on the surface. FIG. 4a depicts safety markings 402, e.g., high visibility lines marking a pathway, which are embedded in the surface of the composite 100. In some embodiments, the indicia 402 may be created by using granules of a different texture, granules of a different finish, or even granules of a different shape or size in place of the colored granules. In some embodiments, the granules may be embedded in the substrate 102 as well as the elastomeric layer 104. Contrasting granules may be added during or after production of the composite. For example, a portion of the elastomeric layer in the composite can be removed in a secondary operation and then filled with different granules. Contrasting granules may also be placed on the substate during the process of adhering the elastomeric surface to the substrate. The indicia of contrasting granules can be the full depth of the surface layer and can be even with the upper surface or can be recessed or raised. For instance, when it is desired that the surface feels consistent to those walking on it, the contrasting granules can be of the same size and hardness and at the same level as the adjoining granules. If a tactile reaction is preferred, the patterns can be slightly recessed or raised so that those walking across the surface become aware of the change. For example, the pattern can be raised or recessed by more than 0.5 mm, more than 1 mm, more than 2 mm or more than 5 mm.

In some embodiments, the composite 100 is fire resistant. Fire resistance can be especially important, particularly in the construction and marine sectors where the composite 100 can be exposed to fires caused by electrical, open flame/welding, flammable liquids and gases, radiant heat, matches, smoking, and accidents. Certain embodiments of the composite 100 meet marine standards for flammability such as ASTM 1317-90 “Standard Test Method for Flammability of Marine Finishes,” and IMO's ISO 9705 test. In some embodiments, fire protection is achieved by using a polymer for the adhesive in the elastomeric layer that is fire resistant. In some embodiments, a fire-retardant additive is added to the adhesive. In some embodiments, an intumescent coating is used on the elastomeric surface 104 of the composite 100. Intumescent coatings can be water-based or epoxy-based. The epoxy products may include Pitt-Char from PPG or Chartek from Texton. The water-based coatings may include Firefighter, NoFire, and Albi products. In some embodiments these coatings are applied to the surface with a thickness of less than 10 mils, less than 5 mils, less than 2 mils. These coatings can be re-applied over the lifetime of the composite without removing the composite from its working location.

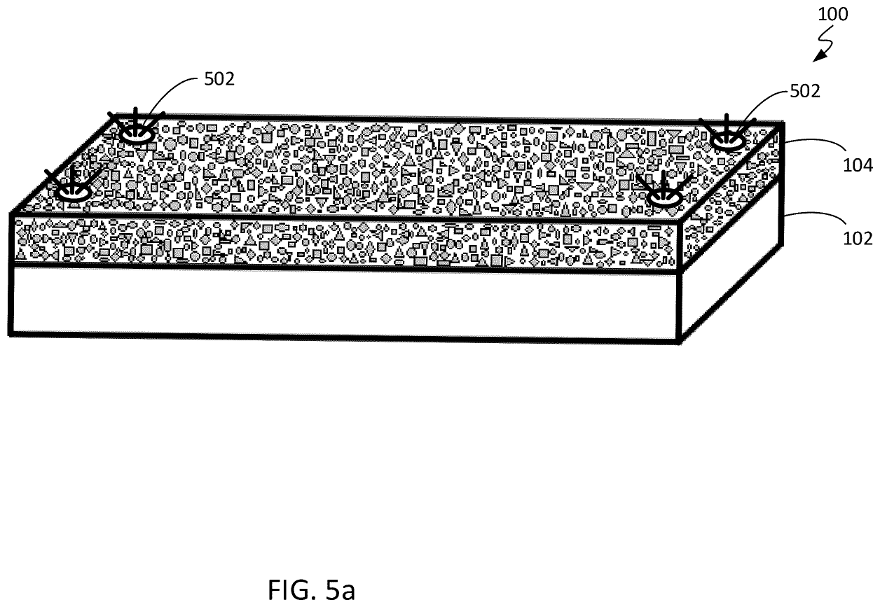

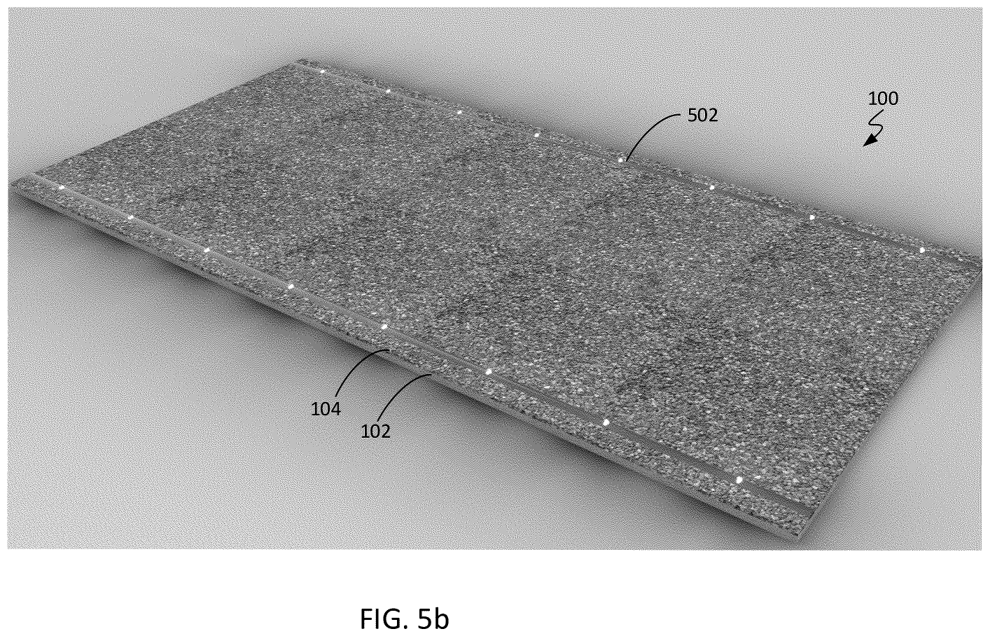

In some embodiments, as shown in FIGS. 5a and 5b, illumination devices 502/504, sensors, or heat tape may be embedded in the surface of the composite 100. Materials may be molded into the composite during production or can be added in a secondary operation after the granules have been adhered to the substrate. For example, as shown in FIG. 5a, LED recessed lights 502 may be embedded to designate a safe walkway. Another example, as shown in FIG. 5b, may include LED or fiber optic strip lighting 504 embedded in the composite 100. Other applications may include embedded photo sensors for light curtains and safety shut offs, embedded LED strip lighting for aesthetic designs or illumination of trip hazards, or embedded heat tape for deicing. Illumination devices may include, LED strip lighting, recessed floor lights, or step lighting. Sensors may include, thermometers, thermostats, capacitive sensors, doppler effect sensors, pressure sensors, strain gauges, motion sensors, atmospheric sampling devices, carbon monoxide detectors, or optical proximity sensors including photoelectric, photocell, laser rangefinder, passive or passive thermal infrared sensors, and optical fiber.

In some embodiments, the composite 100 exhibits antimicrobial characteristics, where the elastomeric surface 104 kills at least 50%, 75%, or 99% surface bacteria that come into contact with the surface. In some embodiments, the composite 100 may be left in exposed marine or other environments for at least 2, 5, 10, or 15 years without any visible microbial growth.

The composite 100 is designed to meet all ADA Accessibility Standards, particularly, ADA § 302 Floor or Ground Surfaces, which states “Floor and ground surfaces shall be stable, firm, and slip resistant and shall comply with § 302. Additionally, when joined, the surfaces also meet § 303 Changes in Level, which states requires that “changes in level of ¼ inch high maximum shall be permitted to be vertical.”

### Example Methods of Manufacture—Polymeric Substrate

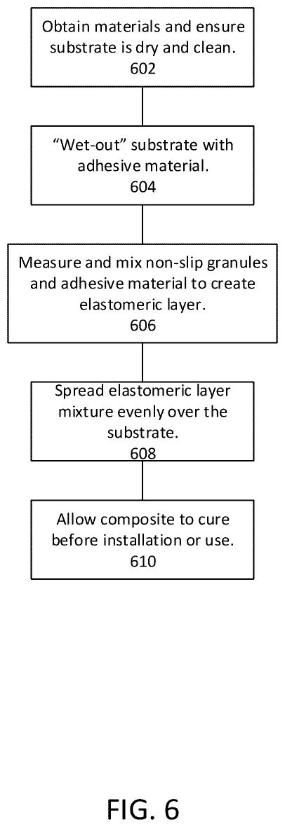

FIG. 6 is an example manufacture of the composite 100 in accordance with the present disclosure. Prior to applying the surface material, substrate 102 must be cleaned and dried to maximize adhesive contact 602.

In some embodiments, the substrate is “wet-out” prior to applying the elastomeric layer 104. As known in the art, “wetting out” means the adhesive flows and covers a surface to maximize the contact area and the attractive forces between the adhesive and the substrate 102. In some embodiments, the substrate 102 is “wet-out” using an adhesive. The surface energy of the adhesive can be as low or lower than the surface energy of the substrate 102 to be bonded. In some embodiments, the material used to wet-out the substrate 102 is the same adhesive used in the elastomeric layer 104. In some embodiments, the substrate 102 must be treated prior to being wet-out to raise the substrate 102 surface energy. A surface treatment may raise the surface energy of the substrate 102 by at least 5%, at least 10%, at least 20%, or at least 30%. Surface treatments may include flame treatment, corona discharge, exposure to UV light, exposure to UV light in the presence of a solvent and etching in chromic acid.

Next, the materials for the elastomeric layer 104, adhesive material and elastomeric granules detailed above, are measured and mixed 606. Various ratios of adhesive to elastomeric granules are detailed above.

Once mixed, the elastomeric layer mixture is troweled evenly over the substrate 102 608. In some embodiments, depth guides are used to ensure the mixture is applied at an even consistency. This mixture may be deposited, formed, or spread over the substrate 102.

Once applied, the elastomeric layer adhesive should be allowed to cure before installation and use of the composite 100 610. In some embodiments, the adhesive material that is used to adhere the elastomeric granules to the substrate 102 is a polymer dispersion adhesive, also referred to as an emulsion adhesive or a one-part adhesive. This adhesive can cure via a chemical reaction with initiation or catalyzation by, for example, radiation, heat, or moisture. Some environmentally preferred embodiments use polymer adhesives that are solvent-free. In some embodiments, the adhesive material is moisture curing. This means that the adhesive cures when they react with moisture present on the substrate 102 surface or in the atmosphere. Moisture curing adhesives include cyanoacrylates and urethanes. In some embodiments, the adhesive material is UV light curing adhesive, also known as a light curing material (LCM). Light curing adhesives cure quickly and can bond dissimilar substrates and withstand harsh temperatures.

### Example Methods of Manufacture—Metal Substrate.

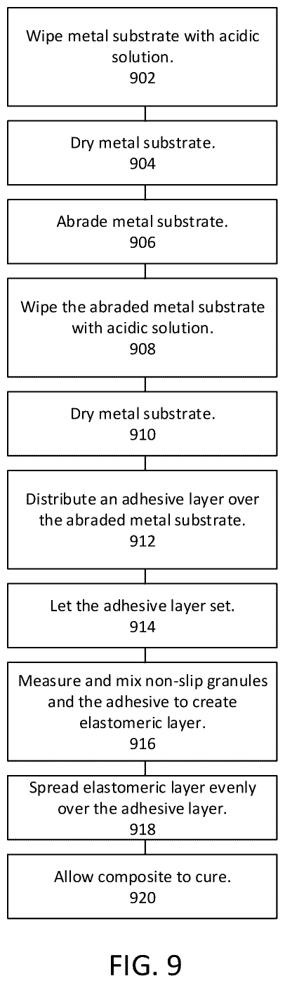

FIG. 9 is an example manufacture of the composite 100 in accordance with the present disclosure, wherein the substrate 102 of the composite 100 includes aluminum. Not all actions are required for all embodiments and additional actions may be included. First, the aluminum substrate is cleaned with an acidic solution 902. In some embodiments, the acidic solution used removes dust, debris, oil, grease, as well as oxidation present on the surface of the substrate. In some cases, the solution may be buffered and/or may have a pH of less than 5.0, less than 4.0, less than 3.0 or less than 2.0. For example, the acidic solution may be a muriatic acid (HCl) or a potassium bitartrate mixed with an aqueous solution of acetic acid. In some embodiments, cleaning can include wiping, scouring, soaking, sponging, rubbing, mopping, or swabbing the substrate with the acidic solution. After cleaning, the aluminum substrate is dried 904. In some embodiments, the clean substrate is dried with clean towels, air, or both. Air used to dry the substrate may be forced, dry, and/or hot. If the substrate is dried using hot air, then the substrate should be cooled to a temperature within the temperature range of the curing environment before proceeding. The substrate can be free of visible water droplets.

At 908, the dried aluminum substrate is abraded. In some embodiments, the aluminum substrate is abraded with sandpaper or emery cloth having a grit size less than 80 grit, 90 grit, 100 grit, or 120 grit. Alternatively, the aluminum substrate may be abraded with a material having a grit size that is greater than 120 grit, 100 grit, or 90 grit. In some embodiments, the surface roughness of the aluminum substrate is measured in accordance with ASTM D7127-17. The surface roughness of the aluminum substrate after abrading may be less than 250 μin, less than 150 μin, less than 100 μin, less than 70 μin, less than 60 μin, or less than 55 μin. In the same or alternative embodiments, the surface roughness after abrading may be greater than 55 μin, greater than 60 μin, greater than 70 μin, greater than 100 μin, greater than 150 μin, or greater than 200 μin. Abrasion of the aluminum substrate may include sandblasting, vapor honing, hand sanding, abrasive wheels, abrasive belts, and abrasive discs.

The abraded aluminum substrate is then cleaned 908 and dried 910 for a second time using similar methods to those detailed in reference to 902 and 904. Once dry, the process as depicted in FIG. 9, continues by distributing an adhesive layer over the abraded aluminum substrate 912. The adhesive is the same adhesive used in the elastomeric layer to bind granules to one another and the mixture to the surface. The adhesive layer can be applied by brushing, rolling, pouring, spin coating, or troweling the adhesive over the abraded substrate. In some embodiments, the adhesive coats the entire abraded surface of the aluminum substrate.

At 914, the adhesive layer is set for less than 30 minutes, 20 minutes, 15 minutes, 10 minutes, or 5 minutes before proceeding. The adhesive layer is “set” once it can no longer be pushed around the abraded surface by the frictional force of the distribution of the elastomeric layer but is also not fully cured. It should remain tacky but should not flow when the substrate is tipped to 45 degrees.

Phrased alternatively, the adhesive layer is set so it remains as both a barrier and bonding agent between the elastomeric layer and the abraded substrate. It is not fully cured at this point.

In some embodiments, after the adhesive layer is set, the elastomeric layer is measured and mixed 916. The materials, measurements, and ratios for the elastomeric granules and the adhesive are provided above in reference to the elastomeric layer structure. The elastomeric granules and adhesive are mixed until all sides of the granules are coated with adhesive. In some embodiments, the elastomeric layer is mixed using a hand stir stick, a vortex mixer, pin mixer, planetary mixer, or a paddle and drill.

Once mixed, the elastomeric layer is troweled or otherwise distributed evenly over the substrate 918. In some embodiments, use of depth guides ensures the mixture is applied at an even depth. A doctor blade can be used to even and smooth the viscous elastomeric layer.

Once applied, the adhesive in the elastomeric layer is cured 920. In some embodiments, the adhesive material that is used is a polymer dispersion adhesive, also referred to as an emulsion adhesive or a one-part adhesive. This adhesive can cure via a chemical reaction with initiation or catalyzation by, for example, radiation, heat, or moisture. Some environmentally preferred embodiments use polymer adhesives that are solvent-free. In some embodiments, the adhesive material is moisture curing. This means that the adhesive cures when it reacts with moisture present on the substrate surface or in the atmosphere. Moisture curing adhesives include cyanoacrylates and urethanes. In some embodiments, the adhesive material is UV light curing adhesive, also known as a light curing material (LCM). Light curing adhesives cure quickly and can bond dissimilar substrates and withstand harsh temperatures.

In some embodiments, the elastomeric layer is cured in a controlled environment 920. This controlled environment allows for the adhesive to cure at optimal and consistent conditions. In some embodiments, the elastomeric layer is cured in an environment where the temperature does not drop below 40, 45, or 50 degrees Celsius. In some embodiments, the elastomeric layer is cured in an environment where the temperature is less than 60, 70, or 80 degrees Celsius. In some embodiments, the relative humidity of the curing environment is less than 60%, 50%, or 40%. In some embodiments, the relative humidity is greater than 20%, 30%, or 35%. In some embodiments, the curing environment is between 50 and 70 degrees Celsius at 30% to 50% relative humidity. In some embodiments, the elastomeric layer may cure for at least 2, 5, 8, 10, 12 or 15 hours.

FIG. 9 can also be used as an example manufacture of the composite 100 in accordance with the present disclosure, wherein the substrate 102 of the composite 100 includes steel. First, the steel substrate is cleaned with a solvent 902. In some embodiments, the solvent used removes dust, debris, oil, grease, as well as oxidation on the surface of the substrate. For example, the solvent may be protic, aprotic or non-polar. Examples include hydrocarbons such as dodecane; tetrahydrofuran, acetone, ethanol, methanol, isopropanol and methyl acetate. In some embodiments, cleaning can include scouring, soaking, sponging, rubbing, mopping, or swabbing the substrate with the solvent. After cleaning, the steel substrate is dried 904. In some embodiments, the cleaned substrate is dried with clean towels, air, or both. Air used to dry the substrate may be forced, dry, and/or hot. If the substrate is dried using hot air, then the substrate should be cooled to a temperature within the temperature range of the curing environment before proceeding.

At 908, the dried steel substrate is abraded. Preferably this is performed before any new corrosion can take place. In some embodiments, abrading the steel substrate is done with material having a grit size less than 120 grit, 150 grit, 180 grit, or 220 grit. Alternatively, the steel substrate may be abraded using a grit size of greater than 220 grit, 180 grit, or 150 grit abrasion. In some embodiments, the steel substrate is abraded for a second time using greater than 320 grit, 400 grit, 500 grit, 600 grit, 700 grit, 800 grit, 1000 grit, or 2000 grit abrasion. Abrasion of the steel substrate may include sandblasting, vapor honing, hand sanding, abrasive wheels, abrasive belts, and abrasive discs. In some embodiments, the surface roughness of the steel substrate is measured in accordance with ASTM D7127-17. The surface roughness of the steel substrate after abrading may be less than 4 μin, less than 3 μin, less than 2 μin, or less than 1 μin. In the same or alternative embodiments, the surface roughness after abrading may be greater than 1 μin, greater than 2 μin, greater than 3 μin, or greater than 4 μin.

The abraded steel substrate is then cleaned 908 and dried 910 using similar methods and materials to those detailed in reference to 902 and 904. Once dry, the process as depicted in FIG. 9, continues by distributing an adhesive layer over the abraded steel substrate 912. The adhesive is the same adhesive used in the elastomeric layer to bind granules to one another and the mixture to the surface. The adhesive layer can be applied by brushing, rolling, pouring, spin coating or troweling the adhesive over the abraded substrate. In some embodiments, the adhesive coats the entire abraded surface of the steel substrate to avoid delamination.

Next, in some embodiments, the adhesive layer is set 914 for less than 30 minutes, 20 minutes, 15 minutes, 10 minutes, or 5 minutes before proceeding. The adhesive layer is set once it can no longer be pushed around the abraded surface by the frictional force of the distribution of the elastomeric layer. Phrased alternatively, the adhesive layer is set so it remains as a barrier and bonding agent between the elastomeric layer and the abraded substrate. It should remain tacky but should not flow when the substrate is tipped to 45 degrees.

In some embodiments, actions 902-914, as depicted in FIG. 9 and described above, are completed on adjacent surfaces to the elastomeric layer surface. This additional pre-treatment of adjacent surfaces further secures the joints and avoids delamination of the elastomeric layer from the steel substrate.

In some embodiments, after the adhesive layer is set, the elastomeric layer is measured and mixed 916. The appropriate materials, measurements, and ratios for the elastomeric granules and the adhesive are provided above in reference to the elastomeric layer structure. The elastomeric granules and adhesive are mixed until all sides of the granules are coated with adhesive. In some embodiments, the elastomeric layer is mixed using a hand stir stick, cement mixer, a vortex mixer, pin mixer, or a paddle and drill.

Once mixed, the elastomeric layer is troweled evenly over the substrate 918. In some embodiments, use of depth guides ensures the mixture is applied at an even depth. A doctor blade can be used to even and flatten the layer. In some embodiments, the layer is distributed over surfaces which have been pre-treated by steps 902-914 to avoid delamination and increase longevity of use.

Once applied, the adhesive in the elastomeric layer is cured 920. In some embodiments, the adhesive material that is used is a polymer dispersion adhesive, also referred to as an emulsion adhesive or a one-part adhesive. This adhesive can cure via a chemical reaction with initiation or catalyzation by, for example, radiation, heat, or moisture. Some environmentally preferred embodiments use polymer adhesives that are solvent-free. In some embodiments, the adhesive material is moisture curing. This means that the adhesive cures when it reacts with moisture present on the substrate surface or in the atmosphere. Moisture curing adhesives include cyanoacrylates and urethanes. In some embodiments, the adhesive material is UV light curing adhesive, also known as a light curing material (LCM). Light curing adhesives cure quickly and can bond dissimilar substrates and withstand harsh temperatures.

In some embodiments, the elastomeric layer 104 is cured in a controlled environment. This controlled environment allows for the adhesive to cure at optimal and consistent conditions. In some embodiments, the elastomeric layer is cured in an environment between 8-40, 10-40, 15-30, 15-25, or 15-20, or 20-30 degrees Celsius. In some embodiments, the elastomeric layer is cured in an environment where the temperature does not drop below 8, 15, 20, 30 or 40 degrees Celsius. In some embodiments, the relative humidity of the curing environment is between 40%-90%, 40%-80%, 40%-70%, 40%-60% or 40%-50%. In some embodiments, the relative humidity of the curing environment is less than 90%, 75%, 60%, 50%, or 40%. In some embodiments, the controlled environment is between 18 and 22 degrees Celsius at 40 to 60% relative humidity. some embodiments, the elastomeric layer 104 may cure for 8-20, 10-15, or 12-14 hours. Alternatively, the elastomeric layer 104 may cure for at least 8, 10, 12 or 15 hours.

In embodiments that include markings in the surface as described above and shown in FIGS. 4a and 4b, after initial curing process of the elastomeric layer 104, the elastomeric layer 104 is removed in the shape of the desired marking. The elastomeric layer 104 can be removed mechanically by being cut, chemically removed, or etched, for example by laser or waterjet. The colored granules 402 and adhesive are then applied to the surface of the substrate 102 in an indicium that creates safety markings. In other embodiments, the markings, like those shown in FIG. 4, are created by depositing the elastomeric layer mixture 104 over the substrate 102 using a mold that leaves negative space on the substrate 102 in the shape of the indicium. Once cured, the markings are spread into the negative space and cured again before installation and use.

In embodiments that include embedded sensors, illumination devices, or heat tape as described above and shown in FIGS. 5a and 5b, the device may be installed during or after formation of the composite. For instance, the device can be laid across the substrate after wetting and the granule/adhesive mixture poured across the top. If the device should be positioned close to the surface, the formation of the elastomeric layer can take place in two steps. In the first step, a layer of granules/adhesive is troweled or otherwise spread over the substrate. The device to be installed is then placed on top of this first layer. A second layer of granules/adhesive is then troweled over the existing layer to form a completed elastomeric layer with the device sandwiched in between.

In some embodiments, embedded devices, as shown in FIG. 4 and described above, may be installed during or after formation of the composite. For instance, a first elastomeric layer may be deposited on the device according to the process in FIG. 9 for aluminum and steel substrates. Once the first elastomeric layer cures, the embedded device is positioned on the surface of the first elastomeric layer. In some embodiments, the device can be secured to the first elastomeric layer. Securing the device avoids risk of the device shifting when the second elastomeric layer is deposited. Next, a second elastomeric layer is deposited over the first elastomeric layer and the embedded devices to form a completed composite. In this embodiment, the completed composite includes an embedded device sandwiched between two elastomeric layers. In some embodiments, a power or communication connector is required for the embedded device. In this embodiment, the power or communication connector may be positioned at the edge of the substrate, where the second elastomeric layer covers the top of the connector but maintains exposure of the connection port. Alternatively, the connector can be positioned in a form or guide, so the second elastomeric layer is deposited around the connector. In this embodiment, the connection port remains exposed at the surface of the elastomeric layer.

To add devices post-curing, a portion of the elastomeric layer 104 is removed to create a negative space for both the device and any required connection elements, such as power cords or communication connections. Portions of the elastomeric layer 104 can be removed by being cut, chemically removed, or laser etched. The illumination devices or sensors 502 are then applied to the composite 100. In some embodiments the substrate 102 may also have to be removed to accommodate components with depths greater than the applied elastomeric layer 104. In those scenarios, the substrate 102 can be removed in a similar fashion by being cut, chemically removed, or laser etched. In some embodiments, the elastomeric layer 104 mixture is used to fill in the remaining negative space after the component is embedded and left to cure again for the recommended times.

In many embodiments, the composite does not off gas upon site installation. Off gassing is the emission of noxious gases often found in manufactured materials. Off gassing can cause mild headaches, nausea, loss of coordination, and eye, nose and throat irritation. These effects can be amplified in enclosed spaces and regulations may limit the amount of off gassing that can occur.

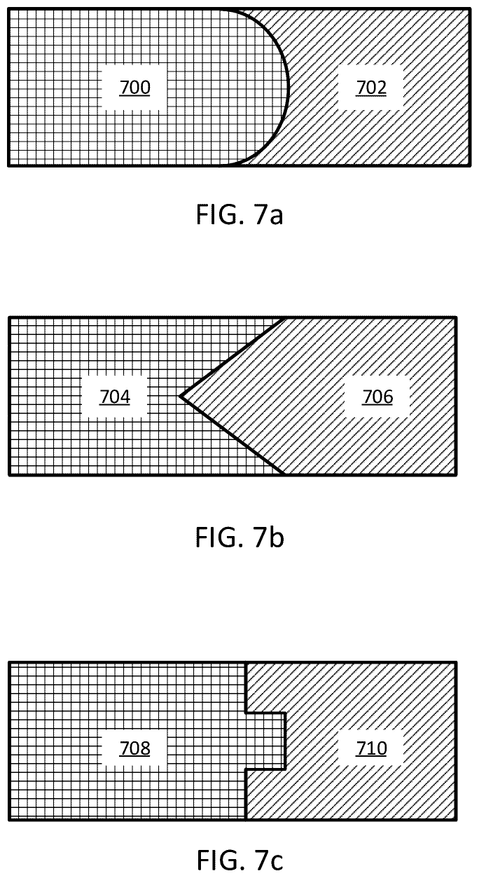

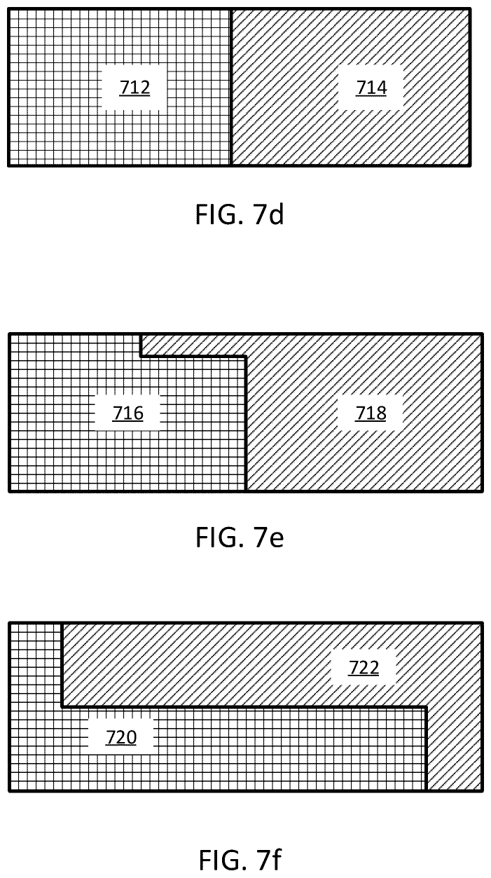

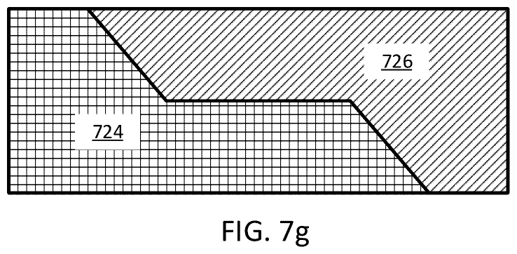

The composite may be installed end to end, or side by side, with additional composite panels to form a working surface. In some embodiments, when installed in this fashion, adjacent composites may comprise beveled, wedged, or tongue and grove edges, as shown in FIGS. 7a-7g respectively. The adjacent composites, such as 701 to 702, 704 to 706, 708 to 710, 712 to 714, 716 to 718, 720 to 722, or 724 to 726 may be attached to one another using an adhesive, traditional mechanical fasteners (such as a bolt), or may be held in place by the friction between the edges. Edges may include electrical or fiber optic connectors as well that provide power or light to various devices in the composite. These connectors can be configured to mate with adjoining connectors on the complementary edge of the adjoining composite sheet.

### Experimental Results

The American Society for Testing and Materials (ASTM) test standards met by one or more embodiments of the composite or its components are listed below. This list is not all encompassing and therefore the composite as disclosed may satisfy additional test standards that are not listed below.

Structural Standards

ASTM D5766M-11 Standard Test Method for Open-Hole Tensile Strength of Polymer Matrix Composite Laminates.

ASTM D5961M-17 Standard Test Method for Bearing Response of Polymer Matrix Composite Laminates.

ASTM D6264M-17 Standard Test Method for Measuring the Damage Resistance of a Fiber-Reinforced Polymer-Matrix Composite to a Concentrated Quasi-Static Indentation Force.

ASTM D6484M-14 Standard Test Method for Open-Hole Compressive Strength of Polymer Matrix Composite Laminates.

ASTM D6742M-17 Standard Practice for Filled-Hole Tension and Compression Testing of Polymer Matrix Composite Laminates.

ASTM D6873M-17 Standard Practice for Bearing Fatigue Response of Polymer Matrix Composite Laminates.

ASTM D7136M-15 Standard Test Method for Measuring the Damage Resistance of a Fiber-Reinforced Polymer Matrix Composite to a Drop-Weight Impact Event.

ASTM D7137M-17 Standard Test Method for Compressive Residual Strength Properties of Damaged Polymer Matrix Composite Plates.

ASTM D7248M-12 Standard Test Method for Bearing/Bypass Interaction Response of Polymer Matrix Composite Laminates Using 2-Fastener Specimens.

ASTM D7332M-16 Standard Test Method for Measuring the Fastener Pull-Through Resistance of a Fiber-Reinforced Polymer Matrix Composite.

ASTM D7615M-11 Standard Test Method for Measuring the Fastener Pull-Through Resistance of a Fiber-Reinforced Polymer Matrix Composite.

ASTM D8066M-17 Standard Practice Unnotched Compression Testing of Polymer Matrix Composite Laminates.

ASTM D8101M-17 Standard Test Method for Measuring the Penetration Resistance of Composite Materials to Impact by a Blunt Projectile.

ASTM D8131M-17e1 Standard Practice for Tensile Properties of Tapered and Stepped Joints of Polymer Matrix Composite Laminates.

Composites for Civil Structures Standards

ASTM D7205M-06 Standard Test Method for Tensile Properties of Fiber Reinforced Polymer Matrix Composite Bars.

ASTM D7290-06 Standard Practice for Evaluating Material Property Characteristic Values for Polymeric Composites for Civil Engineering Structural Applications.

ASTM D7337M-12 Standard Test Method for Tensile Creep Rupture of Fiber Reinforced Polymer Matrix Composite Bars.

ASTM D7522M-15 Standard Test Method for Pull-Off Strength for FRP Laminate Systems Bonded to Concrete Substrate.

ASTM D7565M-10 Standard Test Method for Determining Tensile Properties of Fiber Reinforced Polymer Matrix Composites Used for Strengthening of Civil Structures.

ASTM D7616M-11 Standard Test Method for Determining Apparent Overlap Splice Shear Strength Properties of Wet Lay-Up Fiber-Reinforced Polymer Matrix Composites Used for Strengthening Civil Structures.

ASTM D7617M-11 Standard Test Method for Transverse Shear Strength of Fiber-reinforced Polymer Matrix Composite Bars.

ASTM D7705M-12 Standard Test Method for Alkali Resistance of Fiber Reinforced Polymer (FRP) Matrix Composite Bars used in Concrete Construction.

ASTM D7913M-14 Standard Test Method for Bond Strength of Fiber-Reinforced Polymer Matrix Composite Bars to Concrete by Pullout Testing.

ASTM D7914M-14 Standard Test Method for Strength of Fiber Reinforced Polymer (FRP) Bent Bars in Bend Locations.

ASTM D7957M-17 Standard Specification for Solid Round Glass Fiber Reinforced Polymer Bars for Concrete Reinforcement.

ASTM D7958M-17 Standard Test Method for Evaluation of Performance for FRP Composite Bonded to Concrete Substrate using Beam Test.

Sandwich Construction Standards

ASTM C271M-16 Standard Test Method for Density of Sandwich Core Materials.

ASTM C272M-16 Standard Test Method for Water Absorption of Core Materials for Sandwich Constructions.

ASTM C273M-16 Standard Test Method for Shear Properties of Sandwich Core Materials.

ASTM C297M-16 Standard Test Method for Flatwise Tensile Strength of Sandwich Constructions.

ASTM C363M-16 Standard Test Method for Node Tensile Strength of Honeycomb Core Materials.

ASTM C364M-16 Standard Test Method for Edgewise Compressive Strength of Sandwich Constructions.

ASTM C365M-16 Standard Test Method for Flatwise Compressive Properties of Sandwich Cores.

ASTM C366M-16 Standard Test Methods for Measurement of Thickness of Sandwich Cores.

ASTM C393M-16 Standard Test Method for Core Shear Properties of Sandwich Constructions by Beam Flexure.

ASTM C394M-16 Standard Test Method for Shear Fatigue of Sandwich Core Materials.

ASTM C480M-16 Standard Test Method for Flexure Creep of Sandwich Constructions.

ASTM C481-99 Standard Test Method for Laboratory Aging of Sandwich Constructions.

ASTM D6416M-16 Standard Test Method for Two-Dimensional Flexural Properties of Simply Supported Sandwich Composite Plates Subjected to a Distributed Load.

ASTM D6772M-16 Standard Test Method for Dimensional Stability of Sandwich Core Materials.

ASTM D6790M-16 Standard Test Method for Determining Poisson's Ratio of Honeycomb Cores.

ASTM D7249M-16e1 Standard Test Method for Facing Properties of Sandwich Constructions by Long Beam Flexure.

ASTM D7250M-16 Standard Practice for Determining Sandwich Beam Flexural and Shear Stiffness.

ASTM D7336M-16 Standard Test Method for Static Energy Absorption Properties of Honeycomb Sandwich Core Materials.

ASTM D7766M-16 Standard Practice for Damage Resistance Testing of Sandwich Constructions.

ASTM D7956M-16 Standard Practice for Compressive Testing of Thin Damaged Laminates Using a Sandwich Long Beam Flexure Specimen

ASTM D8067M-17 Standard Test Method for In-Plane Shear Properties of Sandwich Panels Using a Picture Frame Fixture.

ASTM F1645M-16 Standard Test Method for Water Migration in Honeycomb Core Materials.

Editorial and Resource Standards

ASTM D3878-16 Standard Terminology for Composite Materials.

ASTM D4762-16 Standard Guide for Testing Polymer Matrix Composite Materials.

ASTM D6507-16 Standard Practice for Fiber Reinforcement Orientation Codes for Composite Materials.

Lamina and Laminate Standards

ASTM D2344M-16 Standard Test Method for Short-Beam Strength of Polymer Matrix Composite Materials and Their Laminates.

ASTM D3039M-17 Standard Test Method for Tensile Properties of Polymer Matrix Composite Materials.

ASTM D3171-15 Standard Test Methods for Constituent Content of Composite Materials.

ASTM D3410M-16 Standard Test Method for Compressive Properties of Polymer Matrix Composite Materials with Unsupported Gage Section by Shear Loading.

ASTM D3479M-12 Standard Test Method for Tension-Tension Fatigue of Polymer Matrix Composite Materials.

ASTM D3518M-13 Standard Test Method for In-Plane Shear Response of Polymer Matrix Composite Materials by Tensile Test of a ±45° Laminate.

ASTM D3552-17 Standard Test Method for Tensile Properties of Fiber Reinforced Metal Matrix Composites.

ASTM D4255M-15a Standard Test Method for In-Plane Shear Properties of Polymer Matrix Composite Materials by the Rail Shear Method.

ASTM D5229M-14 Standard Test Method for Moisture Absorption Properties and Equilibrium Conditioning of Polymer Matrix Composite Materials.

ASTM D5379M-12 Standard Test Method for Shear Properties of Composite Materials by the V-Notched Beam Method.

ASTM D5448M-16 Standard Test Method for In plane Shear Properties of Hoop Wound Polymer Matrix Composite Cylinders.

ASTM D5449M-16 Standard Test Method for Transverse Compressive Properties of Hoop Wound Polymer Matrix Composite Cylinders.

ASTM D5450M-16 Standard Test Method for Transverse Tensile Properties of Hoop Wound Polymer Matrix Composite Cylinders.

ASTM D5467M-97 Standard Test Method for Compressive Properties of Unidirectional Polymer Matrix Composite Materials Using a Sandwich Beam.

ASTM D5687M-95 Standard Guide for Preparation of Flat Composite Panels with Processing Guidelines for Specimen Preparation.

ASTM D6641M-16e1 Standard Test Method for Compressive Properties of Polymer Matrix Composite Materials Using a Combined Loading Compression (CLC) Test Fixture.

ASTM D6856M-03 Standard Guide for Testing Fabric-Reinforced “Textile” Composite Materials.

ASTM D7028-07 Standard Test Method for Glass Transition Temperature (DMA Tg) of Polymer Matrix Composites by Dynamic Mechanical Analysis (DMA).

ASTM D7078M-12 Standard Test Method for Shear Properties of Composite Materials by V-Notched Rail Shear Method.

ASTM D7264M-15 Standard Test Method for Flexural Properties of Polymer Matrix Composite Materials.

Interlaminar Properties Standards

ASTM D5528-13 Standard Test Method for Mode I Interlaminar Fracture Toughness of Unidirectional Fiber-Reinforced Polymer Matrix Composites.

ASTM D6115-97 Standard Test Method for Mode I Fatigue Delamination Growth Onset of Unidirectional Fiber-Reinforced Polymer Matrix Composites.

ASTM D6415M-06a Standard Test Method for Measuring the Curved Beam Strength of a Fiber-Reinforced Polymer-Matrix Composite.

ASTM D6671M-13e1 Standard Test Method for Mixed Mode I-Mode II Interlaminar Fracture Toughness of Unidirectional Fiber Reinforced Polymer Matrix Composites.

ASTM D7291M-15 Standard Test Method for Through-Thickness “Flatwise” Tensile Strength and Elastic Modulus of a Fiber-Reinforced Polymer Matrix Composite Material.

ASTM D7905M-14 Standard Test Method for Determination of the Mode II Interlaminar Fracture Toughness of Unidirectional Fiber-Reinforced Polymer Matrix Composites.

Other Applicable Standards

ASTM D3389 Standard Test Method for Coated Fabrics Abrasion Resistance

ASTM E1307 Standard Practice for Surface Preparation and Structural Adhesive Bonding of Precured, Nonmetallic Composite Facing to Structural Core for Flat Shelter Panels.

ASTM F607 Standard Test Method for Adhesion of Gasket Materials to Metal Surfaces.

ASTM D7427 Standard Test Method for Immunological Measurement of Four Principal Allergenic Proteins (HEV b 1, 3, 5, and 6.02) in HEVEA Natural Rubber and its Products Derived from Latex.

ASTM D3623 Standard Test Method for Testing Antifouling Panels in Shallow Submergence.

ASTM D297 Standard Test Methods for Rubber Products—Chemical Analysis.

ASTM D2244 Standard Practice for Calculation of Color Tolerances and Color Differences from Instrumentally Measured Color Coordinates.

ASTM D977 Standard Specification for Emulsified Asphalt.

ASTM D575 Standard Test Methods for Rubber Properties in Compression.

ASTM F2966 Standard Guide for Snow and Ice Control for Walkway Surfaces.

ASTM D6370 Standard Test Method for Rubber—Compositional Analysis by thermogravimetry (TGA).

ASTM G154 Standard Practice for Operating Fluorescent Ultraviolet (UV) Lamp Apparatus for Exposure of Nonmetallic Materials.

ASTM G155 Standard Practice for Operating Xenon Arc Light Apparatus for Exposure of Nonmetallic Materials.

ASTM D117 Standard Guide for Sampling, Test Methods, and Specifications for Electrical Insulating Liquids.

ASTM D4060 Standard Test Method for Abrasion Resistance of Organic Coatings.

ASTM E119 Standard Test Methods for Fire Tests of Building Construction and Materials.

ASTM E162 Standard Test Method for Surface Flammability of Materials Using a Radiant Heat Energy Source.

ASTM E662 Standard Test Method for Specific Optical Density of Smoke Generated by Solid Materials.

ASTM E1354 Standard Test Method for Heat and Visible Smoke Release Rates for Materials and Products Using an Oxygen Consumption calorimeter.

49 CFR 238 Brake System Safety Standards for Freight and Other Non-Passenger Trains and Equipment End-of-Train Devices.

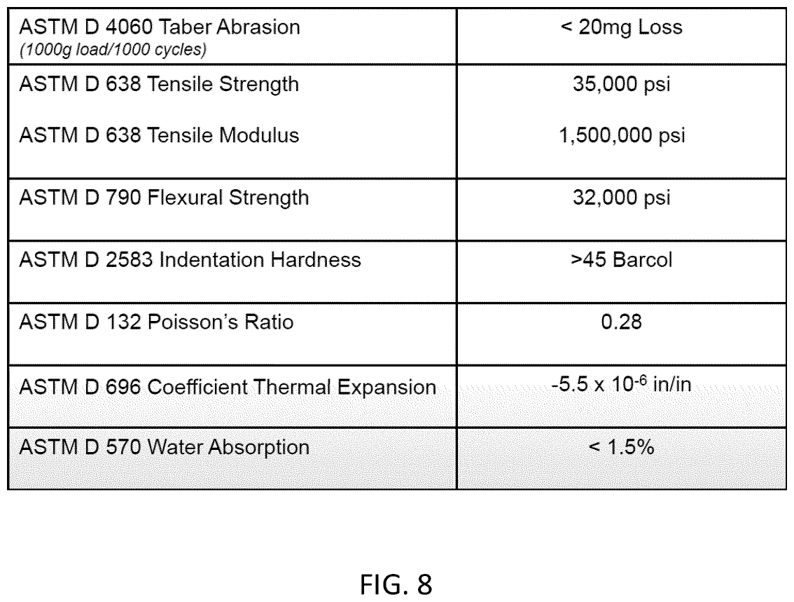

FIG. 8 comprises test results of an embodiment of the composite from particular ASTM test standards.

While several embodiments have been described and illustrated herein, those of ordinary skill in the art readily will envision a variety of other means and/or structures for performing the functions and/or obtaining the results and/or one or more of the advantages described herein, and each of such variations and/or modifications is deemed to be within the scope of the present invention. More generally, those skilled in the art readily will appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain, using no more than routine experimentation, many equivalents to the specific embodiments of the invention described herein. Therefore, it is to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A composite comprising:
a substrate comprising at least one polymer and a reinforcement material;
an elastomeric layer disposed on a surface of the reinforced polymer substrate and adhered to the surface with an adhesive, the elastomeric layer further comprising,
a plurality of elastomeric granules adhered together with the adhesive; and
wherein a tensile force (stress) of at least 35,000 psi is required to separate the elastomeric layer from the reinforced polymer substrate.

2. The composite of claim 1 wherein the elastomeric layer is non-porous.

3. The composite of any preceding claim wherein the adhesive comprises a polyurethane.

4. The composite of any preceding claim, wherein the adhesive used in the production of the composite is a straight-chain aliphatic polyurethane.

5. The composite of any preceding claim, wherein the adhesive used in production of the composite is a flexible binding medium.

6. The composite in any preceding claim, wherein the plurality of elastomeric granules is latex-free.

7. The composite in any preceding claim, wherein the plurality of elastomeric granules is a granulated elastomer.

8. The composite in any preceding claim, wherein the plurality of elastomeric granules is comprised of a synthetic rubber.

9. The composite in any preceding claim, wherein the plurality of elastomeric granules are comprised of Ethylene-Propylene-Diene-Monomer.

10. The composite in any preceding claim, wherein the wet dynamic coefficient of friction of a top surface of the elastomeric layer of the composite is 0.95±0.05.

11. The composite in any preceding claim, wherein each granule of the plurality of elastomeric granules exhibit a size ranging from 1-3.5 mm.

12. The composite of claim 11, wherein the plurality of granules exhibit a size standard deviation of greater than 0.5 mm.

13. The composite of any preceding claim, wherein the plurality of elastomeric granules resists temperatures up to and including 300° F.

14. The composite of any preceding claim, wherein the polymer of the substrate is a polymeric foam.

15. The composite of any preceding claim, wherein the polymer of the substrate is a polyurethane.

16. The composite of any preceding claim, wherein the polymer of the substrate is a high-density, closed-cell polyurethane foam.

17. The composite of any preceding claim, wherein the reinforcement material of the substrate comprises glass fibers.

18. The composite of any preceding claim, wherein the composite is configured to resist fire.

19. The composite of any preceding claim, wherein the composite is configured to resist radiation having a wavelength from 250-320 nm.

20. The composite of any preceding claim, wherein the elastomeric layer comprises an indicium.

21.-124. (canceled)
